(19) United States
(12) Patent Application Publication
(10) Pub. No.: US 2021/0230796 A1
(43) Pub. Date: Jul. 29, 2021

(54) ICEPHOBIC COMPOSITIONS, FABRICS, AND COMPOSITES

(71) Applicant: Precision Fabrics Group, Inc., Greensboro, NC (US)

(72) Inventors: Chester Wiese, Westfield, NC (US); Rene Kapik, Greensboro, NC (US)

(21) Appl. No.: 15/733,946

(22) PCT Filed: Jun. 4, 2019
(86) PCT No.: PCT/US2019/035371

§ 371 Date: Dec. 1, 2020

Related U.S. Application Data
(60) Provisional application No. 62/681,164, filed on Jun. 6, 2018.

(51) Int. Cl. D06M 15/227; D06M 15/643

(52) U.S. Cl. CPC D06M 15/227; D06M 2101/20; D06M 15/643

(57) ABSTRACT

The present invention provides icephobic compositions, fabrics, and composites along with methods of making and using the same. Icephobic compositions and/or coatings of the present invention include a fluorine containing compound (e.g., a fluoropolymer) and/or a silicon containing compound, and optionally a latex binder. In some embodiments, the icephobic fabrics and/or composites include a porous polymer coating.

### RELATED APPLICATION INFORMATION

This application claims the benefit of U.S. Provisional Patent Application Ser. No. 62/681,164, filed Jun. 6, 2018, the disclosure of which is incorporated herein by reference in its entirety.

### FIELD OF THE INVENTION

The present application relates to icephobic compositions, fabrics, and composites along with methods of making and using the same. In some embodiments, the icephobic fabrics and/or composites include a porous polymer coating.

### BACKGROUND

The underbody of an automobile is exposed to extreme weather conditions and is also the site of unwanted noise generated by road, tires, motor and transmission. Any materials used in the underbody of an automobile must be sufficiently durable to maintain functional properties despite frequent buffeting with gravel and paving components.

Current technology relies on solid plastic materials (e.g., high-density polyethylene, acrylonitrile butadiene styrene [ABS]) and/or an uncoated needlepunch nonwoven made of polyester, co-polyester and/or polypropylene that are resistant to the underbody environment of an automobile, but do not provide an effective sound barrier or ice release.

### SUMMARY OF EXAMPLE EMBODIMENTS

One aspect of the present invention is directed to a composition comprising: a latex binder in an amount of about 1% to about 30% by weight of the composition; a repellant in an amount of about 1% to about 30% by weight of the composition, wherein the repellant comprises a fluorine containing compound (e.g., fluoropolymer) and/or a silicon containing compound (e.g., polysiloxane); and water in an amount of about 50% to about 98% by weight of the composition.

A further aspect of the present invention is directed to a fabric comprising a repellant on a first surface of the fabric, wherein the repellant comprises a fluorine containing compound and/or silicon containing compound, optionally wherein the repellant is present in an amount of about 0.1% or 1% to about 30% by weight of the fabric.

Another aspect of the present invention is directed to a composite article comprising: a substrate; and a fabric comprising an icephobic coating on a first surface and a porous polymer coating on a second surface, wherein the second surface contacts at least one surface of the substrate.

A further aspect of the present invention is directed to a method of providing a coated fabric, the method comprising: contacting a fabric with a composition comprising a repellant to provide the coated fabric, wherein the repellant comprises a fluoropolymer and/or a polysiloxane; and drying the coated fabric.

Another aspect of the present invention is directed to a method of providing a composite, the method comprising: contacting a substrate and a fabric, the fabric comprising an icephobic coating on a first surface and a porous polymer coating on a second surface to form the composite, wherein the second surface of the fabric contacts at least one surface of the substrate.

It is noted that aspects of the invention described with respect to one embodiment, may be incorporated in a different embodiment although not specifically described relative thereto. That is, all embodiments and/or features of any embodiment can be combined in any way and/or combination. Applicant reserves the right to change any originally filed claim and/or file any new claim accordingly, including the right to be able to amend any originally filed claim to depend from and/or incorporate any feature of any other claim or claims although not originally claimed in that manner. These and other objects and/or aspects of the present invention are explained in detail in the specification set forth below. Further features, advantages and details of the present invention will be appreciated by those of ordinary skill in the art from a reading of the figures and the detailed description of the preferred embodiments that follow, such description being merely illustrative of the present invention.

### BRIEF DESCRIPTION OF THE DRAWINGS

FIG. 1 is a cross-section view of a fabric including an icephobic coating on a surface of the fabric and in a portion of the fabric according to some embodiments of the present invention.

FIG. 2 is a cross-section view of a fabric including an icephobic coating throughout the fabric according to some embodiments of the present invention.

FIG. 3 is a cross-section view of an icephobic fabric attached to a flat substrate according to some embodiments of the present invention.

FIG. 4 is a cross-section view of an icephobic fabric attached to a shaped or molded substrate according to some embodiments of the present invention.

FIG. 5 is a graph of air permeability versus add-on amount of porous polymer coatings including clay according to some embodiments of the present invention.

FIG. 6 is a graph showing regression for air flow volume delta (%) (difference in air flow before and after bonding to simulate a manufacture's process) versus clay solids (%) in porous polymer coatings according to some embodiments of the present invention.

The accompanying drawings, which are incorporated in and constitute a part of the specification, illustrate embodiments of the invention and, together with the description, serve to explain principles of the invention.

### DETAILED DESCRIPTION

The present invention will now be described more fully hereinafter. This invention may, however, be embodied in different forms and should not be construed as limited to the embodiments set forth herein. Rather, these embodiments are provided so that this disclosure will be thorough and complete, and will fully convey the scope of the invention to those skilled in the art.

The terminology used in the description of the invention herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the present application and relevant art and should not be interpreted in an idealized or overly formal sense unless expressly so defined herein. The terminology used in the description of the invention herein is for the purpose of describing particular embodiments only and is not intended to be limiting of the invention. All publications, patent applications, patents and other references mentioned herein are incorporated by reference in their entirety. In case of a conflict in terminology, the present specification is controlling.

Also as used herein, “and/or” refers to and encompasses any and all possible combinations of one or more of the associated listed items, as well as the lack of combinations when interpreted in the alternative (“or”).

Unless the context indicates otherwise, it is specifically intended that the various features of the invention described herein can be used in any combination. Moreover, the present invention also contemplates that in some embodiments of the invention, any feature or combination of features set forth herein can be excluded or omitted. To illustrate, if the specification states that a complex comprises components A, B and C, it is specifically intended that any of A, B or C, or a combination thereof, can be omitted and disclaimed.

As used herein, the terms “comprise,” “comprises,” “comprising,” “include,” “includes” and “including” specify the presence of stated features, integers, steps, operations, elements, and/or components, but do not preclude the presence or addition of one or more other features, integers, steps, operations, elements, components, and/or groups thereof.

As used herein, the transitional phrase “consisting essentially of” (and grammatical variants) is to be interpreted as encompassing the recited materials or steps “and those that do not materially affect the basic and novel characteristic(s)” of the claimed invention. Thus, the term “consisting essentially of” as used herein should not be interpreted as equivalent to “comprising.”

The term “about,” as used herein when referring to a measurable value such as an amount or concentration and the like, is meant to encompass variations of ±10%, ±5%, ±1%, ±0.5%, or even ±0.1% of the specified value as well as the specified value. For example, “about X” where X is the measurable value, is meant to include X as well as variations of ±10%, ±5%, 1%, ±0.5%, or even ±0.1% of X. A range provided herein for a measureable value may include any other range and/or individual value therein.

Like numbers refer to like elements throughout. In the figures, the thickness of certain lines, layers, components, elements or features may be exaggerated for clarity. The abbreviations “FIG. and “Fig.” for the word “Figure” can be used interchangeably in the text and figures.

It will be understood that when an element is referred to as being “on,” “attached” to, “connected” to, “coupled” with, “contacting,” etc., another element, it can be directly on, attached to, connected to, coupled with or contacting the other element or intervening elements may also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under,” “below,” “lower,” “over,” “upper” and the like, may be used herein for ease of description to describe one element or feature's relationship to another element(s) or feature(s) as illustrated in the figures. It will be understood that the spatially relative terms are intended to encompass different orientations of an element or fabric in use or operation in addition to the orientation depicted in the figures. For example, if the fabric in the figures is inverted, elements described as “under” or “beneath” other elements or features would then be oriented “over” the other elements or features. Thus, the exemplary term “under” can encompass both an orientation of “over” and “under.” The fabric may be otherwise oriented (rotated 90 degrees or at other orientations) and the spatially relative descriptors used herein interpreted accordingly. Similarly, the terms “upwardly,” “downwardly,” “vertical,” “horizontal” and the like are used herein for the purpose of explanation only unless specifically indicated otherwise.

It will be understood that, although the terms “first,” “second,” etc. may be used herein to describe various elements, these elements should not be limited by these terms. These terms are only used to distinguish one element from another. Thus, a “first” element discussed below could also be termed a “second” element without departing from the teachings of the present invention. The sequence of operations (or steps) is not limited to the order presented in the claims or figures unless specifically indicated otherwise.

As used herein, “ASTM” refers to ASTM, International, 100 Barr Harbor Drive, P.O. Box C700, West Conschoken, Pa. 19428-2959 USA.

As used herein, the term “air permeability” refers to the rate of air flow passing perpendicularly through a known area of a material under a prescribed air pressure differential. See, e.g., ASTM Standard D737-04, “Standard Test Method for Air Permeability of Textile Fabrics,” ASTM International (2012) of 0.5 inches of water column pressure drop. Unless otherwise specified, the air permeability measurements described herein are expressed in cubic feet per minute per square foot (hereinafter “cfm”).

As used herein, the term “airflow resistance” refers to the impedence of airflow through a known area of a material under a prescribed air pressure differential. See, e.g., ASTM Standard C522-03, “Standard Test Method for Airflow Resistance of Acoustical Materials,” ASTM International (2009). Unless otherwise specified, the airflow resistance measurements described herein were measured based on ASTM Standard C522-03, “Standard Test Method for Airflow Resistance of Acoustical Materials,” ASTM International (2009). Unless otherwise specified, the air permeability measurements described herein are expressed in Rayls. Air permeability and airflow resistance are reflective of expected acoustic impedance.

As used herein, the term “batt” refers to a sheet or web of unbounded or lightly bonded fibers.

As used herein, the term “blow ratio” refers to the ratio of air to liquid in a porous material (e.g., a foam). For example, if a known volume of liquid was a weight of 20 grams, and air is introduced into the liquid such that an equal volume of the foamed liquid has a weight of 2 grams, the blow ratio of the foamed liquid is 10 (i.e., the foamed liquid has an air to liquid ratio of 10:1).

As used herein, the terms “increase” and “enhance” (and grammatical variants thereof) refer to an increase in the specified parameter of greater than about 1%, 2%, 3%, 4%, 5%, 10%, 15%, 20%, 25%, 30%, 35%, 40%, 45%, 50%, 55%, 60%, 65%, 70%, 75%, 80%, 85%, 90%, 95%, 100%, 125%, 150%, 175%, 200%, 250%, 300% or more.

As used herein, the terms “inhibit”, “decrease,” and “reduce” (and grammatical variants thereof) refer to a decrease in the specified parameter of greater than about 1%, 2%, 3%, 4%, 5%, 10%, 15%, 20%, 25%, 30%, 35%, 40%, 45%, 50%, 55%, 60%, 65%, 70%, 75%, 80%, 85%, 90%, 95%, 99% or more.

It will also be understood that, as used herein, the terms “example,” “exemplary,” and grammatical variations thereof are intended to refer to non-limiting examples and/or variant embodiments discussed herein, and are not intended to indicate preference for one or more embodiments discussed herein compared to one or more other embodiments.

As used herein, the term “latex” refers to an aqueous dispersion or aqueous emulsion of one or more polymers.

As used herein, the term “porous polymer coating” refers to a porous, polymeric structure that controls the passage of air.

As used herein, the term “Rayl” refers to specific acoustic impedance and/or characteristic acoustic impedance of an article. As one skilled in the art will readily appreciate, the acoustic impedance may be defined as one or two units: an MKS unit and a CGS unit. In MKS units, 1 Rayl equals 1 pascal-second per meter (Pa·s-m⁻¹). In CGS unites, 1 Rayl equals 1 dyne-second per cubic centimeter (dyn·s·cm⁻³). 1 CGS Rayl=10 MKS Rayls. Unless otherwise specified, the Rayls measurements described herein are expressed in MKS units.

As used herein, the term “reticulated foam” refers to a foam wherein the majority of the bubbles/cells are not fully intact. In some embodiments, about 1%, 5%, 10%, 15%, 20%, 25%, 30%, 35%, 45%, 50%, 55% 60%, 65%, 70%, 75%, 80%, 85%, 90%, 95%, 96%, 97%, 98%, 99% or 100% of the bubbles/cells within the reticulated foam are open bubbles/cells. In some embodiments, the bubbles/cells are open to the extent that only the common/shared boundaries of the bubbles/cells remain intact.

As used herein, the term “thermally activatable” refers to a material that adhesively bonds when heated.

“Icephobic”, as used herein in reference to a surface (e.g., a surface of a fabric and/or composite), refers to a surface that has an ice adhesion strength (T_{ice}) of less than 100 kPa. An icephobic surface of the present invention comprises an icephobic composition and/or icephobic coating on at least a portion of the surface. An icephobic composition and an icephobic coating as used herein refer to a composition and coating, respectively, that make a surface of a substrate (e.g., a fabric or composite) icephobic or improve icephobicity of the surface compared to the icephobicity in the absence of the composition and/or coating. In some embodiments, an icephobic fabric and/or composite can repel ice from a surface comprising the icephobic composition and/or coating and/or can delay or prevent ice formation on a surface comprising the icephobic composition and/or coating. In some embodiments, an icephobic surface of the present invention can delay or prevent freezing of water condensing on the surface and/or delay or prevent freezing of incoming water on the surface. If ice is formed on an icephobic surface of the present invention, the ice has a weak adhesion strength with the surface so that it can be easily removed, optionally as compared to a surface devoid of the icephobic composition and/or coating. In some embodiments, an icephobic surface of the present invention may release ice with a peeling load of less than about 100, 95, 90, 85, 80, 75, 70, 65, 60, 55, 50, 45, 40, 35, 30, 25, 20, 15, 10, or 5 Newtons as measured in accordance with Toyota Engineering Standard test TSL3618G. The peeling load may be determined prior to and/or after gravel exposure (e.g., gravel exposure as performed in accordance with Toyota Engineering Standard test TSL3618G and/or ASTM D3173-03). In some embodiments, an icephobic surface of the present invention may release ice with a peeling load of less than about 100, 95, 90, 85, 80, 75, 70, 65, 60, 55, 50, 45, 40, 35, 30, 25, 20, 15, 10, or 5 Newtons as measured in accordance with Toyota Engineering Standard test TSL3618G for at least about 1, 2, 3, 4, 5, 6, 7, 8, 9, 10, 11, 12, or more days, weeks, months, or years, optionally during and/or after exposure to environmental conditions (e.g., weather exposure, gravel exposure, etc.).

All publications, patent applications, patents, and other references mentioned herein are incorporated by reference in their entirety.

According to embodiments of the present invention provided herein are icephobic fabrics including a repellant on at least a portion of a surface of the fabric. “Repellant” and “repellants” as used herein refer to fluorine containing compounds (e.g., fluoropolymers) and/or silicon containing compounds (e.g., polysiloxanes and silanes). One or more repellant(s) may be present on and/or in a fabric in an amount of about 0.01%, 0.1%, 0.5%, 1%, or 5% to about 10%, 15%, 20%, 25%, 30%, or 40% by weight of the fabric. In some embodiments, one or more latex binder(s) may be present on and/or in a fabric including a repellant. One or more latex binder(s) may be present on and/or in a fabric in an amount of about 0.01%, 0.1%, 0.5%, 1%, or 5% to about 10%, 15%, 20%, 25%, or 30% by weight of the fabric. In some embodiments, a fabric of the present invention has a dry add-on weight of about 0.01%, 0.1%, 1%, or 5% to about 10%, 15%, 20%, 25%, or 30% by weight of the fabric after contact with a repellant and/or composition of the present invention and drying. The dry add-on weight of the fabric may include one or more repellant(s) and/or one or more latex binder(s). The dry add-on weight for a fabric may be determined after contact of the fabric with a repellant and/or composition of the present invention and drying the coated fabric at 105° F. for 30 minutes to obtain a dried coated fabric. In some embodiments, the dry add-on weight for a fabric may be determined after contact of the fabric with a repellant and/or composition of the present invention and drying the coated fabric at a temperature of about 200° F. to about 400° F., optionally for about 10 seconds to about 1, 2, or 5 minute(s).

In some embodiments, a composition of the present invention (e.g., an icephobic composition) includes at least one repellant. An icephobic composition can be contacted to a fabric to form an icephobic fabric. A composition can be contacted to a surface (e.g., a surface of a fabric) by, for example, dipping, spraying, extruding, submerging, impregnating, saturating, coating, spreading, resin injecting, calendering, and/or the like. The icephobic composition may be in the form of a liquid (e.g., a solution, emulsion, or dispersion). In some embodiments, an icephobic composition is cured on at least a portion of a surface of a fabric and/or forms an icephobic coating on at least a portion of a surface of a fabric. An icephobic composition may comprise, consist essentially of, or consist of one or more repellant(s). In some embodiments, an icephobic composition comprises a repellant in an amount of about 1%, 5%, 10%, 15%, 20%, or 25% to about 30%, 40%, 50%, 60%, 70%, 80%, 90%, or 100% by weight of the icephobic composition. In some embodiments, the icephobic composition comprises a repellant in an amount of about 1%, 5%, 10%, 15%, 20%, 25%, 30%, 35%, 40%, 45%, 50%, 55%, 60%, 65%, 70%, 75%, 80%, 90%, 95%, or 100% by weight of the icephobic composition.

Exemplary fluorine containing compounds include, but are not limited to, fluoropolymers (e.g., C-6 fluoropolymers); fluorotelomers (e.g., C-6 fluortelomers); fluorine containing compounds under the tradename NUVA® such as, e.g., NUVA® 2155, commercially available from Archroma; fluoroalkyl acrylate copolymers such as, e.g., those under the tradename UNIDYNE™ such as, e.g., UNIDYNE™ TG-5502 and UNIDYNE™ TG-5506, available from Daikin Industries, Ltd.; and fluorine containing compounds under the tradename AsahiGuard E-SERIES™ such as, e.g., AG-E100, available from AGC Chemicals. In some embodiments, a fluorine containing compound used in a composition and/or method of the present invention is a film-forming, partially-fluorinated acrylic copolymer (e.g., present in a water based, film-forming, partially-fluorinated acrylic copolymer emulsion) and/or a fluoroalkyl acrylate copolymer (e.g., present in a fluoroalkyl acrylate copolymer emulsion). In some embodiments, the fluorine containing compound is a C-6 fluorine containing compound such as, for example, a C-6 fluorinated (e.g., partially fluorinated) acrylic copolymer and/or a C-6 fluoroalkyl acrylate copolymer.

In some embodiments, a fluorine containing compound and/or composition comprising a fluorine containing compound does not comprise a C-8 fluoropolymer and/or precursor thereof. In some embodiments, a fluorine containing compound and/or a composition comprising a fluorine containing compound is not and/or does not comprise perfluorooctanoic acid (PFOA), perfluorooctanesulfonic acid (PFOS), and/or precursors thereof. PFOA and/or PFOS may not be present in a composition of the present invention at or above detection limits of PFOA and/or PFOS. In some embodiments, a fluorine containing compound and/or a composition comprising a fluorine containing compound does not form and/or break down to PFOA and/or PFOS.

Exemplary silicon containing compounds include, but are not limited to, polysiloxanes (e.g., catalyzed polysiloxane emulsions), silicone hydrides, silicon containing compounds under the tradename StarPel 366 commercially available from StarChem, epoxy silane oligomers such as, e.g., those under the tradename CoatOSil such as, e.g., CoatOSil MP 200, commercially available from Momentive, silicon containing compounds under the tradename SYL-OFF® such as, e.g., SYL-OFF® 7910, commercially available from Dow Corning Europe S.A., and silicon containing compounds under the tradename XIAMETER® (e.g., XIAMETER® MEM-1111 emulsion or DC-1111) commercially available from Dow Corning Europe S.A. In some embodiments, a silicon containing compound used in a composition and/or method of the present invention is a polymerized/crosslinkable polyorganosiloxane or alkoxysilane (e.g., a polymerized/crosslinkable polyorganosiloxane or alkoxysilane emulsion).

A repellant (e.g., a fluorine containing compound or silicon containing compound) may have an ionicity and/or may be present in a composition having an ionicity that is nonionic (e.g., amphoteric) or cationic (e.g., mildly/weakly cationic). In some embodiments, a composition comprising a repellant has a pH in a range of about 2, 2.5, 3, or 3.5 to about 4, 4.5, 5, or 5.5 at 25° C. In some embodiments, a composition comprising a repellant has a pH of about 2, 2.5, 3, 3.5, 4, 4.5, 5, or 5.5 at 25° C.

In some embodiments, a composition comprising a repellant has a solids content (e.g., of a fluorine containing compound or silicon containing compound) in an amount of about 0.05%, 0.1%, 0.5%, 1%, 5%, or 10% to about 15%, 20%, 25%, 30%, 35%, or 40%. In some embodiments, a composition including a repellant has a solids content in an amount of about 5% or 10% to about 15%, 20%, 25%, 30%, 35%, or 40% and the composition is used to contact and/or treat a fabric as described herein. In some embodiments, a composition including a repellant has a solids content in an amount of about 5% or 10% to about 15%, 20%, 25%, 30%, 35%, or 40% and the composition may be added to one or more additional components (e.g., a latex binder and/or water) to prepare an icephobic composition that is used to contact and/or treat a fabric as described herein. In some embodiments, a composition comprising a repellant (e.g., a fluorine containing compound) is a dispersion (e.g., an aqueous dispersion or oil dispersion) or an emulsion (e.g., an aqueous emulsion).

In some embodiments, a composition comprising a repellant may comprise one or more excipients such as, but not limited to, glycols (e.g, tripropylene glycol), isocyanates (e.g., blocked isocyanates), surfactants, and/or rheology modifiers. One or more excipients may be present in a composition comprising a repellant in an amount of about 0.01%, 0.05%, 0.1%, 0.5%, or 1% to about 2%, 5%, or 10% by weight or volume of the composition.

A repellant as described herein may be cross-linkable. In some embodiments, a repellant as described herein repels water and/or is designed for long-term water hold-out. In some embodiments, a repellant may soften a fabric to which it is in contact with. A repellant as described herein may be compatible with a latex binder such as, e.g., those described herein.

In some embodiments, an icephobic composition of the present invention comprises a repellant and a latex binder. One or more latex binder(s) may be present in a composition of the present invention in an amount of about 1%, 5%, 10%, or 15% to about 20%, 25%, or 30% by weight of the composition.

Exemplary latex binders include, but are not limited to, acrylic polymers, styrene-acrylic polymers, acrylonitrile polymers, acrylic-urethane polymers, polyvinyl chloride (PVC) polymers, polyester polymers, acrylonitrile-butadiene polymers (e.g., carboxylated acrylonitrile-butadiene copolymers), and polyvinylidene polymers (e.g., polyvinylidene chloride). In some embodiments, a latex binder has a glass transition temperature from about −50° C., −45° C., −40° C., −30° C., −20° C., or −10° C. to about +10° C., +20° C., +30° C., +42° C., +45° C., +50° C., +60° C., +70° C., or +75° C. In some embodiments, a latex binder has a glass transition temperature from about −10° C. to about +45° C.

In some embodiments, an icephobic composition of the present invention and/or a latex binder present therein may cover and/or coat a portion (e.g., about 1% to about 99%) or all of the fibers exposed at a surface of a fabric upon contact of the fibers with the composition, which may prevent and/or reduce the amount of water that can bind to the fibers. In some embodiments, an icephobic composition of the present invention and/or a latex binder present therein cover and/or coat about 20%, 25%, 30%, 35%, 40%, 45%, 50%, 55%, 60%, 65%, 70%, 75%, 80%, 90%, 95%, 97%, 99%, or 100% of the fibers exposed at a surface of a fabric upon contact of the fibers with the composition. In some embodiments, an icephobic composition of the present invention and/or a latex binder present therein may coat and/or cover at least about 20% or more of the fibers exposed at a surface of a fabric so that minimal fibers are exposed at the surface for water to encapsulate.

Water may be present in an icephobic composition of the present invention. In some embodiments, water is present in an amount of about 50%, 55%, 60%, or 65% to about 70%, 75%, 80%, 85%, 90%, 95%, or 98% by weight of the icephobic composition.

One or more cross-linker(s) may be present in an icephobic composition of the present invention. Exemplary cross-linkers include, but are not limited to, isocyanate cross-linkers (e.g., blocked isocyanate cross-linkers), oxime-blocked isocyanate cross-linkers under the tradename PHOBOL® such as, e.g., PHOBOL® XAN, commercially available from Huntsman, cross-linkers under the tradename Nicca NK Assist such as, e.g., Nicca NK AssistV-2, commercially available from Nicca USA, Inc., and blocked isocyanate cross-linkers under the tradename Trixene Aqua BI 201 commercially available from Ribelin Sales LLC. A cross-linker may be present in an icephobic composition of the present invention in an amount of about 0.1%, 0.5%, 1%, or 2% to about 5%, 6%, 7%, 8%, 9%, or 10% by weight of the composition.

One or more flame retardant(s) may be present in an icephobic composition of the present invention. Exemplary flame retardants include, but are not limited to, non-halogenated flame retardants; alumina trihydrate; phosphorus; metal complexes; inorganic fire retardant additives such as, but not limited to, ammonium polyphosphates, ammonium dihydrogen phosphate, antimony trioxide, sodium antimonate, zinc borate, zirconium oxides, diammonium phosphate, sulfamic acid, salts of sulfamic acid, boric acid, salts of boric acid, and hydrated alumina; and organic fire retardant additives such as, but not limited to, urea polyammonium phosphate, chlorinated paraffins, tetrabromobisphenol-A and oligomers thereof, decabromodiphenyl oxide, hexabromodiphenyl oxide, pentabromodiphenyl oxide, pentabromotoluene, pentabromoethylbenzene, hexabromobenzene, pentabromophenol, tribromophenol derivatives, perchloropentanecyclodecane, hexabromocyclodecone, tris(2,3-dibromopropyl-1)isocyanurate, tetrabromobisphenol-S and derivatives thereof, 1,2-bis(2,3,4,5,6-pentabromophenoxy)ethane, 1,2-bis-(2,4,6-tribromophenoxy)ethane, brominated styrene oligomers, 2,2-bis-(4(2,3-dibromopropyl)3,5-dibromophenoxy)propane, tetrachlorophthalic anhydride, and tetrabromophthalic anhydride. A flame retardant may be present in an icephobic composition of the present invention in an amount of about 1% or 5% to about 10%, 15%, or 20% by weight of the composition.

One or more catalyst(s) may be present in an icephobic composition of the present invention. Exemplary catalysts include, but are not limited to, silicone containing catalysts, organoplatinum compounds, organotin compounds, peroxide and/or condensation-cured chemistries. A catalyst may be present in an icephobic composition of the present invention in an amount of about 0.1%, 0.5%, 1%, or 2% to about 5%, 6%, 7%, 8%, 9%, or 10% by weight of the composition.

One or more additive(s) may be present in an icephobic composition of the present invention. Exemplary additives include, but are not limited to, surfactants, rheology modifiers, foaming aids, colorants, and pigments. In some embodiments, an additive is present in an icephobic composition of the present invention in an amount of about 0.1% or 0.5% to about 1%, 5%, or 10% by weight of the composition.

An icephobic composition of the present invention may comprise a repellant and a latex binder in a ratio of about 5:1 to about 1:5 (latex binder:repellant). For example, the repellant and latex binder may be present in the icephobic composition in a ratio of about 5:1, 4:1, 3:1, 2:1, 1:1, 1:2, 1:3, 1:4, or 1:5 (latex binder:repellant). In some embodiments, an icephobic composition of the present invention comprises a latex binder and a fluorine containing compound (e.g., fluoropolymer), and the latex binder and fluorine containing compound are present in the composition in a ratio of about 1:1 to about 1:3 (latex binder:fluorine containing compound). In some embodiments, an icephobic composition of the present invention comprises a latex binder and a silicon containing compound and the latex binder and silicon containing compound are present in the composition in a ratio of about 3:1 to about 1:1 (latex binder:silicon containing compound).

Some embodiments include contacting a repellant to at least a portion of a surface of a fabric to provide a coated fabric of the present invention. A coated fabric of the present invention may comprise at least one icephobic surface. In some embodiments, a method of providing a coated fabric of the present invention comprises contacting a fabric with an icephobic composition of the present invention (e.g., a composition comprising a repellant and optionally a latex binder) to provide the coated fabric. The method may further comprise drying the coated fabric. In some embodiments, the icephobic composition and/or icephobic coating on the surface of the coated fabric improves icephobicity of the fabric by at least about 5%, 10%, 15%, 20%, 25%, 30%, 35%, 40%, 45%, 50%, 55%, 60%, 65%, 70%, 75%, 80%, 85%, 90%, 95%, 100%, 125%, 150%, 175%, 200%, 250%, 300% or more, optionally as compared to the icephobicity of the fabric without the icephobic composition and/or coating (e.g., prior to contact with the icephobic composition). Improvements in icephobicity may be measured using any methods known to those of skill in the art such as, for example, by determining peeling load in accordance with Toyota Engineering Standard test TSL3618G, optionally determined prior to and/or after environmental or simulated environmental conditions (e.g., gravel exposure as performed in accordance with Toyota Engineering Standard test TSL3618G and/or ASTM D3173-03).

In some embodiments, contacting the fabric with an icephobic composition of the present invention comprises contacting the composition to the fabric in an amount to saturate the fabric. The composition may be contacted to the fabric in an amount to saturate the fabric and/or to provide a wet pickup of greater than 100%, 150%, 200%, 250%, 300%, or more. In some embodiments, the composition is contacted to the fabric in an amount to provide a wet pickup in a range of about 100% or 150% to about 200%, 250%, or 300%.

In some embodiments, contacting the fabric with an icephobic composition of the present invention comprises foaming the composition onto at least a portion of a surface of the fabric. When the composition is foamed onto a surface of a fabric, the foaming may be carried out using a blow ratio of air to composition of about 3:1 to about 6:1, optionally about 4:1 to about 5:1. In some embodiments, when the composition is foamed onto a surface of a fabric, the foam may be applied and/or contacted to the fabric in an amount of about 0.1, 0.5, or 1 oz to about 1.5 or 2 oz.

The coated fabric may be dried, optionally using methods known to those of skill in the art. In some embodiments, drying the coated fabric comprises curing the composition on at least a portion of a surface of the fabric. The drying may be carried out at a temperature of about 200° F. or 300° F. to about 350° F. or 400° F., optionally for about 10, 30, or 45 seconds to about 1, 2, or 5 minute(s).

A method of providing a coated fabric of the present invention may comprise calendering the coated fabric, optionally using methods known to those of skill in the art. In some embodiments, calendering the coated fabric is carried out at a temperature of about 100° C. or 150° C. to about 200° C. or 250° C. and/or at a pressure of about 1,000 pounds per liner inch (pli) to about 2,000 pli. Calendering of the coated fabric may be performed after drying and/or curing of the coated fabric.

Exemplary fabrics that may be contacted with a composition of the present invention include, but are not limited to, woven fabrics, nonwoven fabrics, and knit fabrics. In some embodiments, the fabric is a nonwoven fabric including, but not limited to, spunlaced fabrics, spunbonded fabrics, needlepunched fabrics, stitchbonded fabrics, thermal bonded fabrics, powder bonded fabrics, chemical bonded fabrics, wet laid fabrics and air laid fabrics. In some embodiments, the fabric is a nonwoven fabric and is a spunlace fabric, spunbond fabric, resin bonded fabric, thermal bonded fabric, air-laid pulp fabric, stitchbonded fabric, spunbond-meltblown (SM), spunbond-meltblown-spunbond (SMS), and/or needlepunch fabric. In some embodiments, the fabric comprises a spunlaced nonwoven fabric.

The fabric may have undergone a mechanical treatment such as, but not limited to, calendering, creping, embossing, ring rolling and/or stretching. In some embodiments, the fabric may have been chemically treated for certain properties such as, but not limited to, flame retardancy; oil, alcohol or water repellency; antistatic; antimicrobial; corrosion inhibition; color; binders; and the like.

In some embodiments, the fabric may have a three-dimensional pattern. In some embodiments, the fabric may be a nonwoven fabric comprising a three-dimensional pattern that mimics the three-dimensional texture of a woven textile (e.g., hopsack, terrycloth or twill). In some embodiments, the fabric may comprise a three-dimensional pattern such that one or more surfaces of the fabric (e.g., the face of the fabric) has an average surface roughness of greater than about 5, 10, 20, 30, 40, 50, 60, 70, 75, 80, 90, 100, 125, 150, 175, 200, 250, 300, 350, 400, 450, 500, 550, 600, 650, 700, 750, 800, 850, 900, 950, 1000 or more microns (as measured based on the Kawabata Evaluation System (KES) using a KES-FB4 Surface Roughness Tester and/or as measured using a profilometer, for example).

A fabric may comprise one or more fibers such as, but not limited to, natural fibers and/or synthetic fibers. In some embodiments, a fabric comprises bamboo fibers, camel hair fibers, graphite fibers, cotton fibers, flax fibers, hemp fibers, jute fibers, polylactic acid fibers, silk fibers, sisal fibers, wood pulp and/or wool (e.g., alpaca, angora, cashmere, chiengora, guanaco, llama, mohair, pashmina, chinchilla, sheep and/or vicuña) fibers. In some embodiments, a fabric comprises acrylic fibers, carbon fibers, fluorocarbon fibers, glass fibers (e.g., melt blown glass fibers, spunbonded glass fibers, air laid glass fibers and/or wet laid glass fibers), lyocell fibers, melamine fibers, modacrylic fibers, polyacrylonitrile (e.g., oxidized polyacrylonitrile) fibers, polyamide (e.g., nylon and/or aramid) fibers, polybenzimidazole fibers, polyester fibers, polyimide fibers, polylactic acid fibers, polyolefin (e.g., polyethylene and/or polypropylene) fibers, polyphenylene benzobisoxazole fibers, polyphenylene sulfide fibers, polyvinyl acetate fibers, polyvinyl alcohol fibers, polyvinyl chloride fibers, polyvinyl fluoride fibers, polyvinylidene chloride fibers, rayon fibers, viscose fibers, and/or modified viscose (e.g., silica-modified viscose) fibers and/or zylon fibers. In some embodiments, a fabric comprises cellulosic fibers (e.g., bamboo fibers, cellulose acetate fibers, cellulose triacetate fibers, cotton fibers, flax fibers, hemp fibers, jute fibers, lyocell fibers, ramie fibers, sisal fibers, viscose fibers, rayon fibers, and/or modified viscose (e.g., silica-modified viscose) fibers and/or wood pulp). In some embodiments, a fabric comprises bicomponent fibers. In some embodiments, a fabric comprises continuous fibers. In some embodiments, a fabric comprises a blend of fibers (e.g. rayon and polyester). In some embodiments, a fabric comprises staple fibers. In some embodiments, a fabric comprises polypropylene fibers, polyethylene fibers, polylactic acid fibers, polyester fibers, wood pulp fibers, and/or blends and/or bicomponent fibers thereof. In some embodiments, a fabric comprises polyester fibers (e.g., about 100% polyester fibers).

A fabric used to provide a coated fabric may have a basis weight of about 10, 15, 20, 25, 30, 25, 40, 45, 50, 55, 60, 65, 70, 75, 80, 85, 90, 95, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 420, 440, 460, 480, 500, 520, 540, 560, 580, 600, 650, 700, 750, 800, 850, 900, 950, 1000, 1100, 1200, 1300, 1400, 1500, 1600, 1700, 1800, 1900 or 2000 grams per square meter (gsm) or more. In some embodiments, the fabric has a basis weight of about 10 gsm to about 80 or 150 gsm.

After contacting a repellant and/or composition of the present invention to a fabric, a portion of the repellant and/or composition may be present throughout a portion of the fabric (e.g., throughout a portion of the thickness of the fabric). For example, when a composition of the present invention is contacted to a surface of a fabric, the fabric may absorb and/or soak up a portion of the composition so that the composition is provided in a portion of the fabric. In some embodiments, the repellant and/or composition impregnates and/or is present in about 10%, 15%, 20%, 25%, 30%, 35%, 40%, 45%, 50%, 55%, 60%, 65%, 70%, 75%, 80%, 85%, 90%, 95%, or 100% of the fabric.

A coated fabric of the present invention may comprise an icephobic composition in the form of a coating on a portion of a surface of a fabric. In some embodiments, the repellant in the icephobic composition forms the coating. In some embodiments, the icephobic composition is in the form of a foam, paste, and/or film on a portion of a surface of a fabric. A concentration gradient of the composition or a component thereof (e.g., a repellant) may be provided on and/or in the fabric. The concentration gradient of the composition or a component thereof may increase in concentration in the direction of from a surface opposing the surface on which the composition was contacted to the surface on which the composition was contacted.

A fabric used to prepare a coated fabric of the present invention may comprise a porous polymer coating as described herein. The porous polymer coating may be present on a surface of the fabric that opposes the surface to be contacted with an icephobic composition of the present invention. In some embodiments, a porous polymer coating of the present invention is contacted and/or added to a coated fabric of the present invention, and is added to the surface of the coated fabric opposing the surface contacted with the icephobic composition. In some embodiments, a porous polymer coating of the present invention is as described in U.S. Patent Application Publication No. 2015/0118932 and/or U.S. Application Ser. No. 62/624,353, the contents of each of which are incorporated herein by reference in their entirety.

A coated fabric of the present invention may be used to provide a composite article of the present invention. A composite article of the present invention (i.e., a composite of the present invention) comprises a substrate and a fabric comprising an icephobic coating on a first surface and a porous polymer coating on a second surface, wherein the second surface contacts at least one surface of the substrate. In some embodiments, the substrate is and/or may be attached to an automotive part (e.g., a bumper).

In some embodiments, a method of providing a composite article of the present invention comprises contacting a substrate and a coated fabric, the coated fabric comprising an icephobic coating on a first surface and a porous polymer coating on a second surface to form the composite article, wherein the second surface of the fabric contacts at least one surface of the substrate. In some embodiments, the porous polymer coating on the second surface adheres the fabric to the substrate.

The substrate may comprise a fabric as described herein that is in the same or a different form as the coated fabric and/or comprises the same and/or different fibers as the coated fabric. For example, in some embodiments, the substrate may comprise a woven fabric or a nonwoven fabric. In some embodiments, the substrate is a nonwoven fabric and is a spunlace fabric, spunbond fabric, resin bonded fabric, thermal bonded fabric, air-laid pulp fabric, stitchbonded fabric, spunbond-meltblown (SM), spunbond-meltblown-spunbond (SMS), and/or needlepunch fabric. The substrate may have a basis weight of about 400 gsm to about 800 gsm. The substrate may comprise polypropylene fibers, polyethylene fibers, polylactic acid fibers, polyester fibers, wood pulp fibers, and/or blends and/or bicomponent fibers thereof. In some embodiments, the substrate comprises polyester fibers. In some embodiments, the substrate may comprise polyester fibers and/or wood pulp fibers. In some embodiments, the substrate is a conventional fabric used in the art, such as, but not limited to, an uncoated needlepunch nonwoven made of polyester, co-polyester and/or polypropylene.

A method of providing a composite of the present invention may comprise molding (e.g., hot molding) the substrate and coated fabric together. In some embodiments, molding the substrate and coated fabric together comprises pressing the substrate and fabric together to form a pressed composite. Pressing of the substrate and coated fabric may be carried out at a temperature of about 200° F. or 300° F. to about 400° F. or 500° F., optionally for about 10, 30, or 45 seconds to about 1, 2, or 5 minutes. In some embodiments, the pressed composite may be pressed to a given thickness such as, e.g., about 2 mm to about 6 mm, optionally using an unheated press and/or a room temperature.

In some embodiments, a coated fabric of the present invention is a sound absorbing insulator and/or provides weather resistant properties such as, e.g., ice-shedding. The coated fabric may be used in a molded exterior part of an automobile, tractor, construction vehicle and/or the like. Exemplary exterior parts include, but are not limited to, wheel house liners and/or underbody shields. In some embodiments, a coated fabric and/or composite article of the present invention absorbs and/or blocks sound from travelling into the passenger cabin and provides weather resistant properties such as, e.g., ice-shedding, optionally even after being struck and/or worn by gravel and/or other paving components or debris.

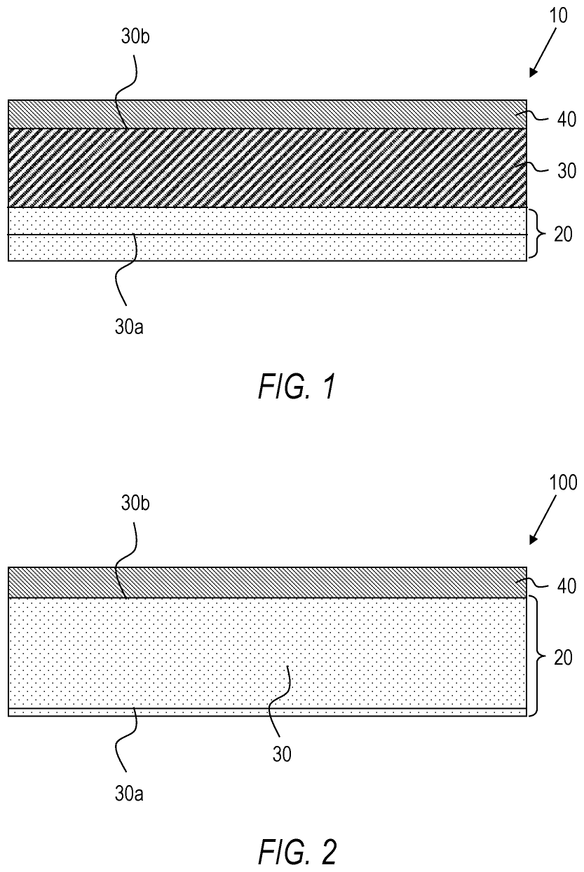

Referring now to FIG. 1, an icephobic fabric 10 of the present invention may comprise an icephobic coating 20 on a first surface 30a of a fabric 30 and a porous polymer coating 40 on a second surface 30b of the fabric 30. The second surface 30b may be the interior side of fabric 30 that faces a substrate (e.g., an automotive part). The icephobic coating 20 may be present on the fabric 30 and in a portion of the fabric 30 (e.g., impregnates a given thickness of the fabric 30 such as e.g., less than about 50% of the total thickness). As shown in FIG. 2, an icephobic fabric 100 may include an icephobic coating 20 that is present throughout the entire thickness of fabric 30, which may be accomplished, e.g., through saturation finishing, optionally prior to the application of the porous polymer coating 40.

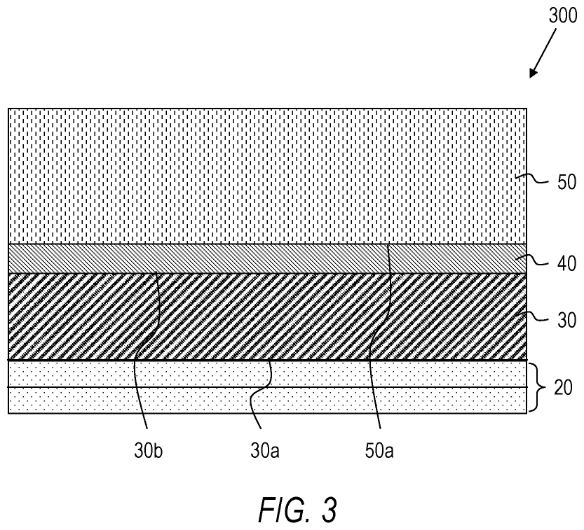

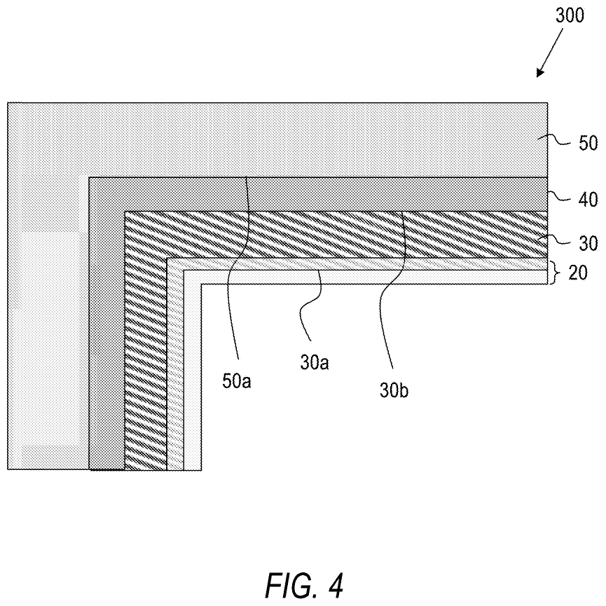

A coated fabric of the present invention may be a single layer of fabric that provides weather resistant properties (e.g., ice prevention and/or ice release properties), durability, and sound absorption. The coated fabric may be attached to a substrate (e.g., a panel or part such as, e.g., an underbody substrate panel) to impart all of these properties to the substrate. For example, a coated fabric 10 may be adhered to a flat substrate 50 (e.g., an underbody panel), as shown in FIG. 3, or to a shaped or molded substrate 50, as shown in FIG. 4, to form a composite article 300 with the porous polymer coating 40 contacting a surface 50a of the substrate 50 such that the second surface 30b of the fabric 30 faces the substrate 50.

In some embodiments, an icephobic fabric of the present invention may include a fabric and/or a composition and/or be prepared as described in Table 1. In some embodiments, an icephobic fabric described in Table 1 (e.g., a coated 100% PET spunlace fabric) may be calendered to prepare the icephobic fabric.

TABLE 1
Example fabrics and icephobic compositions and example application methods.

| | Application | Component | | Weight |
|---|---|---|---|---|
| Fabric | method | Classification | Component | % |
| 100% | Saturation | Latex binder | Acrylic polymers, acrylonitrile | 4-20% |
| PET | Chemistry | | polymers, acrylic-urethane copolymers, | |
| Spunlace | | | acrylic-stryrene copolymers, polyvinyl | |
| | | | chloride polymers, polyester polymers, | |
| | | | carboxylated acrylonitrile-butadiene | |
| | | | coplymers, and/or polyvinylidene | |
| | | | chloride polymers | |
| | | Repellant | Fluoropolymer and/or silicone emulsion | 10-20% |
| | | Cross-linker | Isocyanate cross-linker | 5-10% |
| | | Flame | Organophosphorus flame retardant | 5-10% |
| | | Retardant | | |
| 100% | Foaming | Latex | Acrylic polymers, acrylonitrile | 4-20% |
| PET | Coating | | polymers, acrylic-urethane copolymers, | |
| Spunlace | Chemistry | | acrylic-stryrene copolymers, polyvinyl | |
| | | | chloride polymers, polyester polymers, | |
| | | | carboxylated acrylonitrile-butadiene | |
| | | | coplymers, and/or polyvinylidene | |
| | | | chloride polymers | |
| | | Repellant | Fluoropolymer and/or silicone emulsion | 10-20% |
| | | Cross-linker | Isocyanate cross-linker | 0-5% |
| | | Flame | Organophosphorus flame retardant | 0-5% |
| | | Retardant | | |
| 100% | Saturation | Latex | Acrylic polymers, acrylonitrile | 4-20% |
| PET | Chemistry | | polymers, acrylic-urethane copolymers, | |
| Woven | | | acrylic-stryrene copolymers, polyvinyl | |
| | | | chloride polymers, polyester polymers, | |
| | | | carboxylated acrylonitrile-butadiene | |
| | | | coplymers, and/or polyvinylidene | |
| | | | chloride polymers | |
| | | Repellant | Fluoropolymer and/or silicone emulsion | 10-20% |
| | | Cross-linker | Isocyanate cross-linker | 5-10% |
| | | Flame | Organophosphorus flame retardant | 5-10% |
| | | Retardant | | |
| | | Repellant | Polymerizing silicone emulsion | 10-20% |
| | | Catalyst | Silicone catalyst | 2% |

A coated fabric and/or composite of the present invention may have increased weather resistance and/or ice release compared to a fabric and/or composite devoid of the icephobic composition and/or coating. In some embodiments, a coated fabric and/or composite of the present invention has increased durability compared to a fabric and/or composite devoid of the icephobic composition and/or coating. In some embodiments, a latex binder present on and/or in a coated fabric and/or a mechanical treatment to the coated fabric may enhance durability of the coated fabric and/or composite article and/or may allow one or more icephobic properties of the coated fabric to be maintained even after contact by road debris such as sand and gravel. In some embodiments, a coated fabric and/or composite of the present invention has increased sound absorption compared to a fabric and/or composite devoid of the icephobic composition and/or coating.

In some embodiments, a coated fabric and/or composite of the present invention releases ice with a peeling load of about 1, 2, 5, or 10 Newtons to about 15, 20, 25, 30, 40, 50, 60, 70, 80, 90, or 100 Newtons as measured in accordance with Toyota Engineering Standard test TSL3618G. The peeling load may be determined prior to and/or after gravel exposure (e.g., gravel exposure as performed in accordance with Toyota Engineering Standard test TSL3618G and/or ASTM D3173-03). In some embodiments, the peeling load determined after gravel exposure, as performed in accordance with Toyota Engineering Standard test TSL3618G and/or ASTM D3173-03, increases by less than about 15×, 14×, 13×, 12×, 11×, 10×, 9×, 8×, 7×, 6×, 5×, 4×, 3×, or 2× the peeling load determined prior to gravel exposure, as performed in accordance with Toyota Engineering Standard test TSL3618G and/or ASTM D3173-03. In some embodiments, a coated fabric and/or composite of the present invention releases ice with a peeling load of about 1, 2, 5, or 10 Newtons to about 15, 20, 25, 30, 40, 50, 60, 70, 80, 90, or 100 Newtons as measured in accordance with Toyota Engineering Standard test TSL3618G for at least about 1, 2, 3, 4, 5, 6, 7, 8, 9, 10, 11, 12, or more day(s), week(s), month(s), or year(s), optionally during and/or after exposure to environmental or simulated environmental conditions (e.g., weather exposure, gravel exposure, etc.).

A porous polymer coating of the present invention may comprise any suitable polymer, including, but not limited to, thermoplastic polymers and non-thermoplastic polymers. In some embodiments, porous polymer coatings of the present invention comprise, consist essentially of or consist of one or more thermoplastic polymers and/or one or more non-thermoplastic polymers. In some embodiments, porous polymer coatings of the present invention comprise, consist essentially of or consist of one or more thermoset polymers. In some embodiments, porous polymer coatings of the present invention comprise, consist essentially of or consist of one or more water soluble polymers. In some embodiments, porous polymer coatings of the present invention comprise, consist essentially of or consist of one or more polymers derived from an emulsion or a dispersion (e.g., one or more polymer layers derived from an emulsion or dispersion). In some embodiments, porous polymer coatings of the present invention comprise, consist essentially of or consist of one or more melted and extruded polymers. In some embodiments, porous polymer coatings of the present invention comprise, consist essentially of or consist of one or more copolymers and/or one or more polymer blends. In some embodiments, porous polymer coatings of the present invention comprise, consist essentially of or consist of one or more latex binders.

Porous polymer coatings of the present invention may comprise any suitable thermoplastic polymer, including, but not limited to, polyacrylates, polyvinylacetates, styrene butadiene rubbers, diallylorthophthalates, ionomers, formulated epoxys, polysulfones, perfluorinated polymers and elastomers, polyether-etherketones, acrylonitrilebutadienstyrenes, polycarbonates, vinylesters, styrene copolymers, polyamides, polyamines, ethylenevinylacetates, polyvinyalcohols, polyvinylchlorides, polyvinylidiene chloride, chlorinated polyethylenes, polyesters, nitriles, polyurethanes, polyethylenes, and/or polypropylenes. In some embodiments, porous polymer coatings of the present invention comprise, consist essentially of or consist of one or more thermoplastic copolymers and/or one or more thermoplastic polymer blends. In some embodiments, the porous polymer coatings of the present invention comprise one or more acrylic thermoplastic polymers and one or more copolyester thermoset polymers.

Porous polymer coatings of the present invention may comprise one or more additive(s), including, but not limited to, porogenic agents, adhesive agents, blowing agents, foaming agents, stabilizing agents (e.g., foam stabilizers, thermal stabilizers, light stabilizers, etc.), lubricating agents, tackifying agents, slip agents, elastic agents, antistatic agents, electrically conductive agents, antimicrobial agents (e.g., antibacterial agents, mildewcides, etc.), antifungal agents, coloring agents (e.g., pigments), repellant agents (e.g., water repellants, alcohol repellants, oil repellants, soil repellants, stain repellants, etc), flame retardant agents, UV resistant agents, UV absorption agents and filler agents, such as clay, calcium carbonate, minerals, polymer or mineral (e.g., glass) beads, metallic fillers, and the like. In some embodiments, porous polymer coatings of the present invention comprise one or more active agents. In some embodiments, porous polymer coatings of the present invention comprise one or more agents that increase the durability of the porous polymer coating (and/or a substrate to which the porous polymer coating is applied). For example, the porous polymer coating may comprise one or more isocyanates (e.g., blocked ioscyanates). In some embodiments, porous polymer coatings of the present invention comprise one or more flame retardant chemistries or additives. For example, the porous polymer coating may comprise one or more flame retardant antimony compounds (e.g., antimony oxides), one or more flame retardant boron compounds (e.g., ammonium borate, borax, boric acid, ethanolammonium borate and/or zinc borate), one or more flame retardant halogen compounds (e.g., ammonium bromide, ammonium chloride, brominated/chlorinated binders, brominated/chlorinated additives and/or brominated/chlorinated paraffin), one or more flame retardant nitrogen compounds (e.g., monoammonium phosphate, diammonium phosphate, ammonium borate, ammonium bromide, ammonium chloride, ammonium polyphosphate, melamine, and/or urea), organic and inorganic containing compounds, phosphorous containing compounds (e.g. ammonium polyphosphate), and/or one or more flame retardant sulfur compounds (e.g., ammonium sulfamate). In some embodiments, porous polymer coatings of the present invention comprise one or more antistats. For example, the porous polymer coating may comprise one or more salts, sodium chloride, sodium nitrate, sodium sulfate, or phosphate esters and/or one or more quaternary ammonium compounds.

In some embodiments, a porous polymer coating of the present invention comprises a clay (e.g., hydrated silica-aluminate or kaolin) and/or a pigment having an aspect ratio (i.e., a ratio of width:height) in a range of about 2:1 to about 100:1 such as, for example, in a range of about 2:1 to about 20:1, about 5:1 to about 50:1, about 8:1 to about 15:1, or 5:1 to about 20:1. In some embodiments, the clay and/or a pigment has an aspect ratio of about 2:1, 5:1, 10:1, 15:1, 20:1, 25:1, 30:1, 35:1, 40:1, 45:1, 50:1, 55:1, 60:1, 65:1, 70:1, 75:1, 80:1, 85:1, 90:1, 95:1, or 100:1. In some embodiments, the clay and/or a pigment has an aspect ratio of about 10:1. In some embodiments, a porous polymer coating of the present invention comprises delaminated and/or high-aspect ratio clay. Example clays include, but are not limited to, those such as Kaepaque 10S (30-40:1 Aspect Ratio) and “Hyper Platy” kaolins such as Imerys Hydrite® SB60 (60:1 Aspect Ratio) and Imerys Hydrite® SB100 Aspect Ratio 100:1, each commercially available from Imerys Kaolin.

The clay and/or a pigment may have a particle size in a range of about 0.001 μm to about 100 μm such as, for example, in a range of about 0.001 μm to about 50 μm, about 0.01 μm to about 10 μm, about 0.1 μm to about 20 μm, about 0.1 μm to about 5 μm, or about 1 μm to about 75 μm. In some embodiments, the clay and/or a pigment has a particle size of about 0.001, 0.005, 0.01, 0.05, 0.1, 0.5, 1, 5, 10, 15, 20, 25, 30, 35, 40, 45, 50, 55, 60, 65, 70, 75, 80, 85, 90, 95, or 100 μm. In some embodiments, the clay and/or a pigment has a particle size of about 1 μm.

The clay and/or a pigment may have a whiteness (as quantified by L value using Technical Association of the Pulp and Paper Industry (TAPPI) Test Method T 560 entitled “CIE whiteness and tint of paper and paperboard (d/O geometry, C/2 illuminant/observer), Test Method T 560 om-10”) in a range of about 70 to about 100 such as, for example, in a range of about 80 to about 100 or about 90 to about 100. In some embodiments, the clay and/or a pigment has a whiteness (as quantified by L value using TAPPI Test Method T 560) of about 70, 75, 80, 85, 90, 95, or 100. In some embodiments, the clay and/or a pigment has a whiteness (as quantified by L value using TAPPI Test Method T 560) of about 95.

The clay and/or a pigment may have a brightness (as quantified using TAPPI Test Method T 452 entitled “Brightness of pulp, paper, and paperboard (directional reflectance at 457 nm), Test Method T 452 om-08”) in a range of about 70 to about 100 such as, for example, in a range of about 80 to about 100 or about 90 to about 100. In some embodiments, the clay and/or a pigment has a brightness (as quantified using TAPPI Test Method T 452) of about 70, 75, 80, 85, 90, 95, or 100. In some embodiments, the clay and/or a pigment has a brightness (as quantified using TAPPI Test Method T 452) of about 89.

The clay and/or a pigment may have a hardness (quantified in accordance with the Mohs Hardness Test and Scale) in a range of about 2 to about 5 such as, for example, in a range of about 2 to about 4 or about 2 to about 3. In some embodiments, the clay and/or a pigment has a hardness (quantified in accordance with the Mohs Hardness Test and Scale) of about 2, 3, 4, or 5. In some embodiments, the clay and/or a pigment has a hardness (quantified in accordance with the Mohs Hardness Test and Scale) of about 3.

The clay and/or a pigment may have a mean refractive index in a range of about 1.50 to about 1.60. In some embodiments, the clay and/or a pigment has a mean refractive index of about 1.50, 1.51, 1.52, 1.53, 1.54, 1.55, 1.56, 1.57, 1.58, 1.59, or 1.60. In some embodiments, the clay and/or a pigment has a mean refractive index of about 1.56.

The clay and/or a pigment may be present in a porous polymer coating of the present invention in an amount of about 1% to about 40% by weight (dry) of the final coating solids such as, for example, about 1% to about 20%, about 2% to about 30%, or about 2% to about 10% by weight (dry) of the final coating solids. In some embodiments, the clay and/or a pigment is present in the porous polymer coating in an amount of about 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, or 40% by weight (dry) of the final coating solids. “Dry final coating solids weight”, “dry weight”, or “weight (dry) of the final coating solids” as used herein refer interchangeably to the dry weight of the final coating and/or a component thereof. The dry weight may be obtained by applying a wet porous polymer coating formulation of the present invention onto a substrate and drying the formulation to about 0% moisture such as, e.g., on production equipment. In some embodiments, the dry weight is obtained by a measurement of percent solids by placing 1 gram of a wet porous polymer coating formulation of the present invention in an aluminum weigh pan, weighing the formulation (i.e., the first weight measurement), drying the formulation at 105° F. for 30 minutes to obtain a dried formulation, allowing the dried formulation to cool to room temperature in a desiccator (about one hour), and weighing the dried formulation (i.e., the second weight measurement) to thereby obtain the percent solids, which is calculated by taking the second weight measurement divided by the first weight measurement. When the dry weight is used in reference to the amount of a component (e.g., clay) present in the dry coating, the dry weight of the component is the weight portion of the component in the dry coating. For example, in a formulation having clay present in an amount of 40% by weight (dry) of the final coating solids (also referred to as by dry weight of the final solids content of the polymeric foam or coating), when there are 100 grams of the dried coating, then 40 grams of clay would be present in the dried coating.

In some embodiments, a porous polymer coating of the present invention may be used to impart a specific air permeability and/or acoustic property to a substrate such as, e.g., fabrics used in various applications including, but not limited to, application in automotive, aerospace, engine compartment, carpet, headliner, etc. The coating may be in contact with and/or be applied to a nonwoven fabric (e.g., a flame retardant, water resistant, and/or high elongation nonwoven fabric) and may impart air flow resistance properties consistent with acoustic performance (as measured in rayls). In some embodiments, a porous polymer coating of the present invention may function as an adhesive allowing a substrate (e.g., a fabric) to be attached to another material such as, but not limited to, fiber glass batting, polyethylene terephthalate (PET) batting, foam, carpet, etc., and may also maintain air flow resistance, thereby imparting acoustical absorption. In some embodiments, a porous polymer coating of the present invention may be in contact with and/or applied to any air permeable surface to impart appropriate air flow resistance to achieve the acoustic performance, optionally without a fabric substrate. Thus, in some embodiments, a porous polymer coating of the present invention may not be in contact with and/or applied to a fabric.

It was unexpectedly discovered that by incorporating a clay and/or pigment as described herein can provide a porous polymer coating of the present invention with improved stability of air flow resistance and/or air permeability. In some embodiments, a porous polymer coating of the present invention may have improved stability of air flow resistance and/or air permeability upon exposure of the coating to certain conditions and/or processes such as, e.g., during transport and/or storage in a supply chain, in a subsequent manufacturing process, and/or after exposure to high temperature and/or pressure. In some embodiments, “high temperature” refers to a temperature of about 180° F. or greater such as, for example, from about 180° F. to about 200° F., 300° F., or 400° F. In some embodiments, “high pressure” refers to a pressure of about 5 pounds per square inch (psi) or greater such as, for example, from about 5, 10, 15, 20, 25, or 30 psi. In some embodiments, a porous polymer coating of the present invention may have improved stability of air flow resistance and/or air permeability upon exposure of the coating to certain conditions and/or processes by maintaining the air flow resistance and/or air permeability of the coating after exposure to the certain conditions and/or processes within ±25% (e.g., within +25%, ±20%, ±15%, ±10%, or less) of the air flow resistance and/or air permeability of the coating prior to the exposure to certain conditions and/or processes. In some embodiments, a composite material comprising a porous polymer coating of the present invention that is in contact with and/or adhered to a fabric may have improved stability of air flow resistance and/or air permeability upon exposure of the composite material to certain conditions and/or processes by maintaining the air flow resistance and/or air permeability of the composite material after exposure to the certain conditions and/or processes within ±25% of the air flow resistance and/or air permeability of the composite material prior to the exposure to certain conditions and/or processes. Current coating technologies frequently have air resistances or air permeabilities that change significantly upon exposure to high temperatures and/or pressures. This is often encountered in the fabrication of an acoustic article where part-molding or attachment processes include elevated temperatures and pressures in a roll nip or part mold. Elevated temperatures can also be encountered in the supply chain (e.g., warehouse or truck trailer without environmental control).

In some embodiments, a porous polymer coating of the present invention obviates “hold-out properties” (i.e., properties that hold a flowable coating on a surface of a substrate (e.g., a fabric)) of the base substrate (e.g., a fabric). This may allow for a wider variety of base substrates (e.g., base fabrics) and/or allow for the elimination of a finishing step prior to coating the base substrate, which reduces cost and waste and can provide a more stable acoustical product.

In some embodiments, a porous polymer coating of the present invention may comprise one or more (e.g., 1, 2, 3, 4, 5, or more) surfactants. In some embodiments, one or more surfactants are present in an amount of about 0.1% to about 30% by weight (wet) of the coating such as, for example, about 0.1% to about 10%, about 1% to about 8%, or about 20% to about 30% by weight (wet) of the coating. In some embodiments, a porous polymer coating of the present invention comprises one or more surfactants with each surfactant being present in an amount of about 0.1% to about 10% by weight (wet) of the coating. Water may be present in a porous polymer coating of the present invention in an amount of about 25% to about 90% by weight (wet) of the coating. One or more clays and/or pigments may be present in a porous polymer coating of the present invention in an amount of about 0.5% to about 70% by weight (wet) of the coating. One or more inert functional pigments and/or flame retardants (e.g., non-halogen flame retardants) may be present in a porous polymer coating of the present invention in an amount of about 0% to about 70% by weight (wet) of the coating. One or more polymers may be present in a porous polymer coating of the present invention in an amount of about 2% to about 90% by weight (wet) of the coating. One or more pH adjusting agents (e.g., a base or acid) may be present in a porous polymer coating of the present invention in an amount of about 0% to about 2% by weight (wet) of the coating. One or more thickening agents (e.g., an alkali swellable thickener) may be present in a porous polymer coating of the present invention in an amount of about 0% or 0.1% to about 3% by weight (wet) of the coating. One or more biocides may be present in a porous polymer coating of the present invention in an amount of about 0% or 0.01% to about 2% by weight (wet) of the coating. One or more fluorochemicals may be present in a porous polymer coating of the present invention in an amount of about 0% or 0.1% to about 10% by weight (wet) of the coating. One or more coloring agents may be present in a porous polymer coating of the present invention in an amount of about 0% to about 5% by weight (wet) of the coating. In some embodiments, a blow ratio (i.e., the ratio of air to coating fluid volume) for the porous polymer coating is about 1:1 to about 20:1 and, in some embodiments, about 5:1.

Exemplary porous polymer coatings are described below in Table 2.

TABLE 2
Exemplary Porous Polymer Coatings.

| | Formula- | Formula- | Formula- | Example |
|---|---|---|---|---|
| | tion A | tion B | tion C | Range |
| | (% by | (% by | (% by | (% by |
| | weight, | weight, | weight, | weight, |
| Components | wet) | wet) | wet) | wet) |
| Water | 35.35% | 36.35% | 35.35% | 25-90% |
| Dispersant Surfactant | 0.5% | 0.5% | 0.5% | 0-8% |
| (may be used to | | | | |
| disperse clay into | | | | |
| slurry) | | | | |
| Kaolin Clay | 8.75% | 3.0% | 0 | 0.5-70% |
| (High Aspect Ratio | | | | |
| >10:1) | | | | |
| (Barrier/Filler, may | | | | |
| control air flow volume | | | | |
| for acoustic properties | | | | |
| also for air flow | | | | |
| stability) | | | | |
| Alumina Trihydrate | 8.75% | 14.5% | 17.5% | 0-70% |
| (ATH) | | | | |
| (Non-Halogen Flame | | | | |
| Retardant/Inert | | | | |
| functional pigment that | | | | |
| may release water | | | | |
| molecules at elevated | | | | |
| temperature (e.g. at | | | | |
| 220° C. or more) in an | | | | |
| endothermic reaction) | | | | |
| PVC Emulsion (+10 | 39% | 39% | 39% | 2-90% |
| to +14 Tg) | | | | |
| (Thermoplastic binder | | | | |
| that may be used for | | | | |
| film formation/adhesion/ | | | | |
| flame retardancy) | | | | |
| Ammonium Stearate | 1.5% | 1.5% | 1.5% | 0.1-10% |
| (Surfactant, Foaming | | | | |
| Agent/may refine | | | | |
| and/or stabilize foam | | | | |
| structure) | | | | |
| N-Octl- | 1.75% | 1.75% | 1.75% | 0.1-10% |
| Sulfosuccinamate | | | | |
| (Surfactant, Foaming | | | | |
| Agent. | | | | |
| Amount/loading of this | | | | |
| surfactant may be | | | | |
| adjusted to achieve the | | | | |
| appropriate Blow | | | | |
| Ratio. For example, | | | | |
| with a loading of | | | | |
| 1.75%, the Blow Radio | | | | |
| may be in a range of | | | | |
| 1:1-20:1) | | | | |
| Ammonium | 0.5% | 0.5% | 0.5% | 0-2% |
| Hydroxide | | | | |
| (may be used to adjust | | | | |
| compound pH and/or | | | | |
| activate alkali | | | | |
| swellable thickener) | | | | |
| Alkali Swellable | 1.3% | 1.3% | 1.3% | 0.1-3% |
| Thickener | | | | |
| (Viscosity Modifier. | | | | |
| Increased viscosity | | | | |
| may be needed to place | | | | |
| the foam at the surface | | | | |
| of the substrate during | | | | |
| application process, | | | | |
| creating a continuous | | | | |
| film layer that may | | | | |
| reduce air | | | | |
| permeability.) | | | | |
| Biocide | 0.1% | 0.1% | 0.1% | 0.01-2% |
| (may control mold | | | | |
| grown in tote) | | | | |
| Fluorochemical | 2.0% | 1.0% | 2.0% | 0.1-10% |
| (may provide water | | | | |
| repellency properties) | | | | |
| Carbon Black | 0.5% | 0.5% | 0.5% | 0-5% |
| Pigment | | | | |
| (Optional coloring | | | | |
| agent) | | | | |

In some embodiments, Formulation A may be used with an untreated greige fabric. Formulation A with its higher Koalin Clay content than Formulation B or C may be used on a porous, unfinished, easily penetrated fabrics since the clay pigment may provide more air flow resistance (less permeability) per add-on unit. In some embodiments, Formulation B may be used with a material that is pretreated in an initial finishing process step. Formulation B contains less clay than Formulation A, but more ATH (alternative pigment), which may make it better for a less porous, finished fabric (finish is generally done for other properties such as water resistance, flame resistance etc. that can also provide coating hold out on the surface).

Further exemplary porous polymer coatings are described below in Table 3. The air permeability and airflow resistance of the porous polymer coatings can be modulated by adjusting porosity thereof (e.g., by adjusting the blow ratio, drying conditions and/or chemical additives used during formation).

TABLE 3
Further Exemplary Porous Polymer Coatings.

| | | Formula | Formula | Formula | Formula |
|---|---|---|---|---|---|
| | | 1 | 2 | 3 | 4 |
| Ingredient | Description | (grams) | (grams) | (grams) | (grams) |
| Water | Carrier medium | 75 | | | 160 |
| Binder | Polymer dispersion | 196 | | | |
| | or emulsion | | | | |
| Flovan CGN | Phosphate based | | | 70 | 40 |
| | flame retardant | | | | |
| Exolit 462 | Phase 2 APP | 24 | | | |
| | encapsulated with | | | | |
| | melamine | | | | |
| Unifroth | Anionic foaming | 2.5 | | | |
| 144 | agent | | | | |
| Stanfax 320 | Ammonium | 2.5 | 6 | 12 | 12 |
| | stearate | | | | |
| Synthebond | Styrene acrylate | | 200 | 154 | 90 |
| SA 110 | copolymer | | | | |
| | dispersion | | | | |
| Fuller PN- | Styrene acrylate | | 100 | | |
| 3691-M | copolymer | | | | |
| | emulsion | | | | |
| Synthebond | Styrene acrylate | | | 154 | 90 |
| SA103 | copolymer | | | | |
| | dispersion | | | | |
| Ammonyx | Lauramine oxide | | 6 | 8 | 8 |
| LO | | | | | |
| Aqueous | Base for pH | | | 2 | 2 |
| Ammonium | adjustment | | | | |
| Hydroxide | | | | | |

Porous polymer coatings of the present invention may be formed using any suitable method/composition/apparatus for introducing air into a polymer dispersion or emulsion, including, but not limited to, blowing agents, foaming agents, volatile liquids, commercial mixers (e.g., Hobart® (Troy, Ohio) mixers, KitchenAid® (St. Joseph, Mich.) mixers, etc.) and commercial foam generator systems (e.g., the CFS® System by Gaston Systems, Inc. of Stanley, N.C.). As will be appreciated by one skilled in the art, the porosity and/or consistency of the porous polymer coating may be selectively adjusted (i.e., tuned) by changing the constituents of the porous polymer coating and/or the tool/attachment/settings used to mix the polymer dispersion. For example, the porosity and/or consistency of a porous polymer coating may be selectively adjusted by changing the speed at which the polymer dispersion is mixed and/or the attachment with which the polymer dispersion is mixed.

Porous polymer coatings of the present invention may have any suitable basis weight. In some embodiments, the porous polymer coating has a basis weight of about 1, 2, 3, 4, 5, 6, 7, 8, 9, 10, 15, 20, 25, 30, 25, 40, 45, 50, 55, 60, 65, 70, 75, 80, 85, 90, 95, 100 grams per square meter (gsm) or less. In some embodiments, the porous polymer coating has a basis weight of about 1, 2, 3, 4, 5, 6, 7, 8, 9, 10, 15, 20, 25, 30, 25, 40, 45, 50, 55, 60, 65, 70, 75, 80, 85, 90, 95, 100 gsm or more. In some embodiments, a porous polymer coating of the present invention is applied to a substrate (e.g., a fabric) that has a basis weight of about 10 to about 100 gsm.

Porous polymer coatings of the present invention may have an airflow resistance of about 100, 125, 150, 175, 200, 225, 250, 300, 350, 400, 450, 500, 550, 600, 650, 700, 750, 800, 850, 900, 950, 1000, 1050, 1100, 1150, 1200, 1250, 1300, 1350, 1400, 1450, 1500, 1600, 1700, 1800, 1900, 2000, 2100, 2200, 2300, 2400, 2500, 2600, 2700, 2800, 2900, 3000, 3200, 3400, 3600, 3800, 4000, 4200, 4400, 4600, 4800, 5000, 5500, 6000, 6500, 7000, 7500, 8000, 8500, 9000, 9500, 10000 Rayls or more when tested based on ASTM Standard C522-03, “Standard Test Method for Airflow Resistance of Acoustical Materials,” ASTM International (2009). In some embodiments, the porous polymer coating has an airflow resistance of between about 100 and about 10,000 Rayls.

Porous polymer coatings of the present invention may have an air permeability of about 1, 2, 3, 4, 5, 6, 7, 8, 9, 10, 11, 12, 13, 14, 15, 16, 17, 18, 19, 20, 25, 30, 35, 40, 45, 50, 55, 60, 65, 70, 75, 80, 85, 90, 95, 100, 110, 120, 130, 140, 150 cfm or less. In some embodiments, the porous polymer coating has an air permeability of between about 3 and about 100 cfm.

Porous polymer coatings of the present invention may have any suitable porous structure, including, but not limited to, reticulated porous structures and intact porous structures. In some embodiments, the porous polymer coating comprises a low density, reticulated foam structure. In some embodiments, the porous polymer coating comprises a reticulated foam structure formed by drying an intact foam structure such that intact bubbles/cells are converted to open bubbles/cells. In some embodiments, the porous polymer coating has a void fraction of about 5%, 10%, 15%, 20%, 25%, 30%, 35%, 40%, 45%, 50%, 55%, 60%, 65%, 70%, 71%, 72%, 73%, 74%, 75%, 76%, 77%, 78%, 79%, 80%, 81%, 82%, 83%, 84%, 85%, 86%, 87%, 88%, 89% 90%, 91%, 92%, 93%, 94%, 95%, 96%, 97%, 98%, 99% or more.

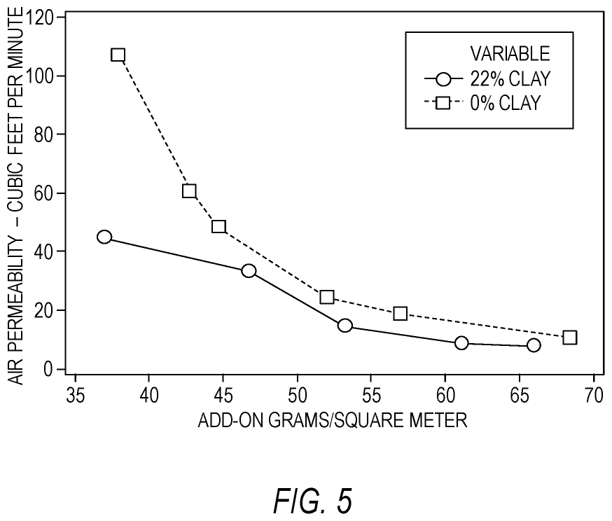

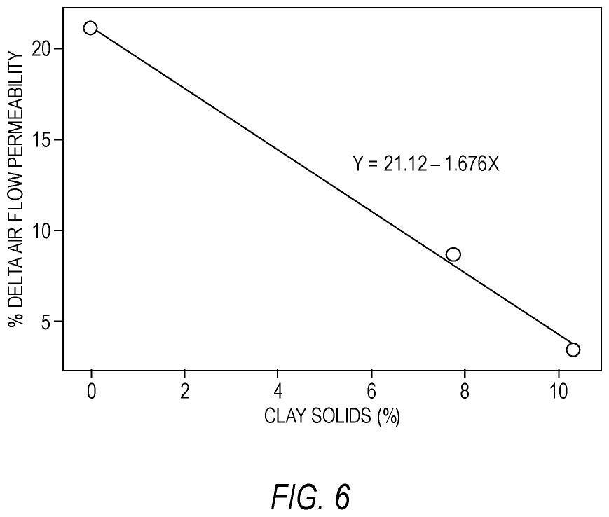

Porous polymer coatings of the present invention may retain their porous structure following compression (as shown in FIGS. 3-4) and/or molding to a substrate (as shown in FIGS. 5-6). In some embodiments, the void fraction of the porous polymer coating is reduced by about 1%, 2%, 3%, 4%, 5%, 6%, 7%, 8%, 9%, 10%, 15%, 20%, 25%, 30%, 35%, 40%, 45%, 50%, 55%, 60%, 65%, 70%, 75%, 80%, 85%, 90%, 95% or less following heat activation and molding/bonding to one or more substrates. In some embodiments, the void fraction of the porous polymer coating is reduced by about 10%, about 25%, about 50% or about 75% following heat activation and molding/bonding to one or more substrates.

Porous polymer coatings of the present invention may have any suitable blow ratio. In some embodiments, the porous polymer coating has a blow ratio of about 1, 2, 3, 4, 5, 6, 7, 8, 9, 10, 11, 12, 13, 14, 15, 16, 17, 18, 19, 20 or more. In some embodiments, the porous polymer coating has a blow ratio of between about 1 and about 10.

Porous polymer coated substrates of the present invention may be subsequently bonded to an additional sound absorbing material to form a multilayer product that has enhanced air flow resistance and/or improved sound absorbing capability. The bonding of the inventive substrate to the additional sound absorbing material is facilitated by the adhesive properties of the coating. The products produced in this way include, but are not limited to, molded sound absorbing panels for vehicles and aircraft, bonded sound absorbing panels for architectural use, sound absorbing materials for ductwork, acoustic and musical end uses such as speakers, panels for auditoriums, and the like.

Porous polymer coatings of the present invention may be applied to a substrate having any suitable basis weight. In some embodiments, a porous polymer coating of the present invention is applied to a substrate (e.g., a fabric) that has a basis weight of about 10, 15, 20, 25, 30, 25, 40, 45, 50, 55, 60, 65, 70, 75, 80, 85, 90, 95, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 420, 440, 460, 480, 500, 520, 540, 560, 580, 600, 650, 700, 750, 800, 850, 900, 950, 1000, 1100, 1200, 1300, 1400, 1500, 1600, 1700, 1800, 1900 or 2000 gsm or less. In some embodiments, a porous polymer coating of the present invention is applied to a substrate (e.g., a fabric) that has a basis weight of about 10, 15, 20, 25, 30, 25, 40, 45, 50, 55, 60, 65, 70, 75, 80, 85, 90, 95, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 420, 440, 460, 480, 500, 520, 540, 560, 580, 600, 650, 700, 750, 800, 850, 900, 950, 1000, 1100, 1200, 1300, 1400, 1500, 1600, 1700, 1800, 1900, 2000 gsm or more. In some embodiments, a porous polymer coating of the present invention is applied to a substrate (e.g., a fabric) that has a basis weight of about 10 to about 100 gsm.

Porous polymer coatings of the present invention may be applied to a substrate having any suitable airflow resistance. In some embodiments, a porous polymer coating of the present invention is applied to a substrate (e.g., a fabric) that has an airflow resistance of about 1, 2, 3, 4, 5, 6, 7, 8, 9, 10, 20, 30, 40, 50, 60, 70, 80, 90, 100, 125, 150, 175, 200, 225, 250, 300, 350, 400, 450, 500, 550, 600, 650, 700, 750, 800, 850, 900, 950, 1000, 1050, 1100, 1150, 1200, 1250, 1300, 1350, 1400, 1450, 1500, 1600, 1700, 1800, 1900, 2000, 2100, 2200, 2300, 2400, 2500 Rayls or more when tested based on ASTM Standard C522-03, “Standard Test Method for Airflow Resistance of Acoustical Materials,” ASTM International (2009). In some embodiments, the porous polymer coating of the present invention is applied to a substrate (e.g., a fabric) that has an airflow resistance of between about 10 and about 1,000 Rayls.

Porous polymer coatings of the present invention may be applied to a substrate having any suitable air permeability. In some embodiments, a porous polymer coating of the present invention is applied to a substrate (e.g., a fabric) that has an air permeability of about 2, 10, 15, 20, 25, 30, 35, 40, 45, 50, 55, 60, 65, 70, 75, 80, 85, 90, 95, 100, 110, 120, 130, 140, 150, 160, 170, 180, 190, 200, 210, 220, 230, 240, 250, 260, 270, 280, 290, 300, 310, 320, 330, 340, 350, 400, 450, 500, 550, 600, 650, 700, 750, 800, 850, 900, 950, 1000 cfm or more. In some embodiments, the porous polymer coating is applied to a substrate (e.g., a fabric) that has an air permeability of between about 10 and about 1,000 cfm/sq. ft., based on ASTM Standard D737-04, “Standard Test Method for Air Permeability of Textile Fabrics,” ASTM International (2012).

Porous polymer coatings of the present invention may be applied to a substrate that is a polymeric foam. Examples include, but are not limited to, urethane foam, foamed rubber both natural and synthetic, foamed polymers such as olefins, polystyrene, acrylates, styrene butadiene, and mixtures of polymers.

Porous polymer coatings of the present invention may be applied to a carpet, which may enhance the sound absorption of the carpet and/or allow for thermally activated bonding of the carpet to another material or surface. Additionally, a substrate, coated with the porous coating of the present invention may be bonded to the back of carpet to enhance the sound absorption of the carpet in use.

Porous polymer coatings of the present invention may be applied using any suitable method, including, but not limited to, knife coating, scrape coating, kiss coating, gap coating, foam coating, spray coating, roll coating, gravure coating, screen printing, slot coating, electrostatic coating and/or starved die coating. In some embodiments, the application process comprises greater than partially melting the porous polymer coating. The airflow resistance of the porous polymer coating may remain the same (or substantially the same) following application (e.g., following the activation and adhesive bonding of the porous polymer coating to one or more substrates). The airflow resistance of the porous polymer coating may change in a predictable manner following application (e.g., following the activation and adhesive bonding of the porous polymer coating to one or more substrates). The porosity or permeability of the coating or coated substrate may be further modified by calendering, embossing, crushing, and/or chemical treatment.

Porous polymer coatings of the present invention may impart and/or modulate any suitable characteristic to/of the substrate(s). In some embodiments, the porous polymer coating imparts one or more adhesive properties to and/or modulates one or more adhesive properties of the substrate(s). For example, the porous polymer coating may impart adhesive properties that allow two or more substrates to be molded together to form a composite material. Similarly, the porous polymer coating may increase the adhesiveness of a substrate by about 1%, 2%, 3%, 4%, 5%, 6%, 7%, 8%, 9%, 10%, 15%, 20%, 25%, 30%, 35%, 40%, 45%, 50%, 55%, 60%, 65%, 70%, 75%, 80%, 85%, 90%, 95%, 100%, 125%, 150%, 175%, 200%, 250%, 300% or more. In some embodiments, the porous polymer coating imparts one or more acoustic properties to and/or modulates one or more acoustic properties of the substrate(s). For example, the porous polymer coating may lower the air permeability of a substrate by about 1%, 2%, 3%, 4%, 5%, 6%, 7%, 8%, 9%, 10%, 15%, 20%, 25%, 30%, 35%, 40%, 45%, 50%, 55%, 60%, 65%, 70%, 75%, 80%, 85%, 90%, 95% or more. Likewise, the porous polymer coating may increase the airflow resistance of a substrate by about 1%, 2%, 3%, 4%, 5%, 6%, 7%, 8%, 9%, 10%, 15%, 20%, 25%, 30%, 35%, 40%, 45%, 50%, 55%, 60%, 65%, 70%, 75%, 80%, 85%, 90%, 95%, 100%, 125%, 150%, 175%, 200%, 250%, 300% or more. In some embodiments, the porous polymer coating modulates the strength of the substrate(s). For example, the porous polymer coating may increase the strength of the substrate(s) by about 1%, 2%, 3%, 4%, 5%, 6%, 7%, 8%, 9%, 10%, 15%, 20%, 25%, 30%, 35%, 40%, 45%, 50%, 55%, 60%, 65%, 70%, 75%, 80%, 85%, 90%, 95%, 100%, 125%, 150%, 175%, 200%, 250%, 300% or more. In some embodiments, the porous polymer coating modulates the durability of the substrate(s). For example, the porous polymer coating may increase the durability of the substrate(s) by about 1%, 2%, 3%, 4%, 5%, 6%, 7%, 8%, 9%, 10%, 15%, 20%, 25%, 30%, 35%, 40%, 45%, 50%, 55%, 60%, 65%, 70%, 75%, 80%, 85%, 90%, 95%, 100%, 125%, 150%, 175%, 200%, 250%, 300% or more. In some embodiments, the porous polymer coating modulates the abrasion resistance of the substrate(s). For example, the porous polymer coating may increase the abrasion resistance of the substrate(s) 6%, 7%, 8%, 9%, by about 1%, 2%, 3%, 4%, 5%, 10%, 15%, 20%, 25%, 30%, 35%, 40%, 45%, 50%, 55%, 60%, 65%, 70%, 75%, 80%, 85%, 90%, 95%, 100%, 125%, 150%, 175%, 200%, 250%, 300% or more.

Composite articles and materials of the present invention may have any suitable basis weight. In some embodiments, composite materials of the present invention have a basis weight of about 10, 15, 20, 25, 30, 25, 40, 45, 50, 55, 60, 65, 70, 75, 80, 85, 90, 95, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 420, 440, 460, 480, 500, 520, 540, 560, 580, 600, 650, 700, 750, 800, 850, 900, 950, 1000, 1100, 1200, 1300, 1400, 1500, 1600, 1700, 1800, 1900, 2000 gsm or less. In some embodiments, composite materials of the present invention have a basis weight of about 10, 15, 20, 25, 30, 25, 40, 45, 50, 55, 60, 65, 70, 75, 80, 85, 90, 95, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 420, 440, 460, 480, 500, 520, 540, 560, 580, 600, 650, 700, 750, 800, 850, 900, 950, 1000, 1100, 1200, 1300, 1400, 1500, 1600, 1700, 1800, 1900, 2000 gsm or more.

Fabrics and/or composite materials of the present invention may demonstrate reduced air permeability. In some embodiments, the air permeability of a fabric and/or composite material is reduced by about 1%, 2%, 3%, 4%, 5%, 6%, 7%, 8%, 9%, 10%, 15%, 20%, 25%, 30%, 35%, 40%, 45%, 50%, 55%, 60%, 65%, 70%, 75%, 80%, 85%, 90%, 95%, 96%. 97%, 98%, 99% or 100% as compared to a control substrate (i.e., a substrate that lacks the porous polymer coating and/or icephobic coating but is otherwise identical to the fabric/composite material) when tested based on ASTM Standard C522-03, “Standard Test Method for Airflow Resistance of Acoustical Materials,” ASTM International (2009); ASTM Standard D737-04, “Standard Test Method for Air Permeability of Textile Fabrics,” ASTM International (2012). In some embodiments, the substrate is a fabric (e.g., a nonwoven fabric), and the air permeability of the composite material is reduced by about 1%, 2%, 3%, 4%, 5%, 6%, 7%, 8%, 9%, 10%, 15%, 20%, 25%, 30%, 35%, 40%, 45%, 50%, 55%, 60%, 65%, 70%, 75%, 80%, 85%, 90%, 95%, 96%. 97%, 98%, 99% or 100% as compared to a control fabric having the same amounts/types of fibers, weight, thickness as the fabric of the composite material.

Fabrics and/or composite materials of the present invention may demonstrate enhanced airflow resistance. In some embodiments, the airflow resistance of a fabric and/or composite material is increased by about 1%, 2%, 3%, 4%, 5%, 6%, 7%, 8%, 9%, 10%, 15%, 20%, 25%, 30%, 35%, 40%, 45%, 50%, 55%, 60%, 65%, 70%, 75%, 80%, 85%, 90%, 95%, 100%, 125%, 150%, 175%, 200%, 250%, 300% or more as compared to a control substrate (i.e., a substrate that lacks the porous polymer coating and/or icephobic coating but is otherwise identical to the composite material) when tested based on ASTM Standard C522-03, “Standard Test Method for Airflow Resistance of Acoustical Materials,” ASTM International (2009); ASTM Standard D737-04, “Standard Test Method for Air Permeability of Textile Fabrics,” ASTM International (2012). In some embodiments, the substrate is a fabric (e.g., a nonwoven fabric), and the airflow resistance of the composite material is increased by about 1%, 2%, 3%, 4%, 5%, 6%, 7%, 8%, 9%, 10%, 15%, 20%, 25%, 30%, 35%, 40%, 45%, 50%, 55%, 60%, 65%, 70%, 75%, 80%, 85%, 90%, 95%, 100%, 125%, 150%, 175%, 200%, 250%, 300% or more as compared to a control fabric having the same amounts/types of fibers, weight, thickness as the fabric of the composite material.

Fabrics and/or composite materials of the present invention may have an airflow resistance of about 100, 150, 200, 250, 300, 350, 400, 450, 500, 550, 600, 650, 700, 750, 800, 850, 900, 950, 1000, 1050, 1100, 1150, 1200, 1250, 1300, 1350, 1400, 1450, 1500, 1600, 1700, 1800, 1900, 2000, 2100, 2200, 2300, 2400, 2500, 2600, 2700, 2800, 2900, 3000, 3200, 3400, 3600, 3800, 4000, 4200, 4400, 4600, 4800, 5000, 5500, 6000, 6500, 7000, 7500, 8000, 8500, 9000, 9500, 10000 Rayls or more when based on ASTM Standard C522-03, “Standard Test Method for Airflow Resistance of Acoustical Materials,” ASTM International (2009); ASTM Standard D737-04, “Standard Test Method for Air Permeability of Textile Fabrics,” ASTM International (2012). In some embodiments, a fabric and/or composite material has an airflow resistance of about 100 to about 10,000 Rayls. In some embodiments, a fabric and/or composite material comprises, consists essentially of or consists of one substrate and one porous polymer coating and has an airflow resistance of about 100, 150, 200, 250, 300, 350, 400, 450, 500, 550, 600, 650, 700, 750, 800, 850, 900, 950, 1000, 1050, 1100, 1150, 1200, 1250, 1300, 1350, 1400, 1450, 1500, 1600, 1700, 1800, 1900, 2000, 2100, 2200, 2300, 2400, 2500, 2600, 2700, 2800, 2900, 3000, 3200, 3400, 3600, 3800, 4000, 4200, 4400, 4600, 4800, 5000, 5500, 6000, 6500, 7000, 7500, 8000, 8500, 9000, 9500, 10000 Rayls or more. In some embodiments, the composite material comprises, consists essentially of or consists of one substrate and one porous polymer coating and has an airflow resistance of about 100 to about 10,000 Rayls. In some embodiments, the composite material comprises, consists essentially of or consists of a porous polymer coating interposed between two substrates and has an airflow resistance of about 100, 150, 200, 250, 300, 350, 400, 450, 500, 550, 600, 650, 700, 750, 800, 850, 900, 950, 1000, 1050, 1100, 1150, 1200, 1250, 1300, 1350, 1400, 1450, 1500, 1600, 1700, 1800, 1900, 2000, 2100, 2200, 2300, 2400, 2500, 2600, 2700, 2800, 2900, 3000, 3200, 3400, 3600, 3800, 4000, 4200, 4400, 4600, 4800, 5000, 5500, 6000, 6500, 7000, 7500, 8000, 8500, 9000, 9500, 10000 Rayls or more. In some embodiments, the composite material comprises, consists essentially of or consists of a porous polymer coating interposed between two substrates and has an airflow resistance of about 100 to about 10,000 Rayls.

Fabrics and/or composite materials of the present invention may demonstrate enhanced strength. In some embodiments, the strength of a fabric and/or composite material is increased by about 1%, 2%, 3%, 4%, 5%, 6%, 7%, 8%, 9%, 10%, 15%, 20%, 25%, 30%, 35%, 40%, 45%, 50%, 55%, 60%, 65%, 70%, 75%, 80%, 85%, 90%, 95%, 100%, 125%, 150%, 175%, 200%, 250%, 300% or more as compared to a control material (i.e., a substrate that lacks the porous polymer coating and/or icephobic coating but is otherwise identical to the fabric/composite material) when tested in based on ASTM Standard D1682-64, “Standard Test Methods for Breaking Load and Elongation of Textile Fabrics,” ASTM International (1975); ASTM Standard D5034-09, “Standard Test Methods for Breaking Load and Elongation of Textile Fabrics (Grab Test),” ASTM International (2013); ASTM Standard D5035-11, “Standard Test Methods for Breaking Load and Elongation of Textile Fabrics (Strip Method),” ASTM International (2011); ASTM Standard D1117-01, “Standard Guide for Evaluating Nonwoven Fabrics,” ASTM International (2001). In some embodiments, the substrate is a fabric (e.g., a nonwoven fabric), and the strength of the composite material is increased by about 1%, 2%, 3%, 4%, 5%, 6%, 7%, 8%, 9%, 10%, 15%, 20%, 25%, 30%, 35%, 40%, 45%, 50%, 55%, 60%, 65%, 70%, 75%, 80%, 85%, 90%, 95%, 100%, 125%, 150%, 175%, 200%, 250%, 300% or more as compared to a control fabric having the same amounts/types of fibers, weight, thickness as the fabric of the composite material.

Fabrics and/or composite materials of the present invention may demonstrate enhanced durability. In some embodiments, the durability of a fabric and/or composite material is increased by about 1%, 2%, 3%, 4%, 5%, 6%, 7%, 8%, 9%, 10%, 15%, 20%, 25%, 30%, 35%, 40%, 45%, 50%, 55%, 60%, 65%, 70%, 75%, 80%, 85%, 90%, 95%, 100%, 125%, 150%, 175%, 200%, 250%, 300% or more as compared to a control material (i.e., a substrate that lacks the porous polymer coating and/or icephobic coating but is otherwise identical to the fabric/composite material) when based on ASTM Standard D4157-13, “Standard Test Method for Abrasion Resistance of Textile Fabrics (Oscillatory Cylinder Method),” ASTM International (2013); ASTM Standard D4158-08, “Standard Guide for Abrasion Resistance of Textile Fabrics (Uniform Abrasion),” ASTM International (2012); ASTM Standard D3389-10, “Standard Test Method for Coated Fabrics Abrasion Resistance,” ASTM International (2010); ASTM Standard D3885-07a, “Standard Test Method for Abrasion Resistance of Textile Fabrics (Flexing and Abrasion Method),” ASTM International (2011); ASTM Standard D3886-99, “Standard Test Method for Abrasion Resistance of Textile Fabrics (Inflated Diaphragm Apparatus),” ASTM International (2011); ASTM Standard D4966-12, “Standard Test Method for Abrasion Resistance of Textile Fabrics (Martindale Abrasion Tester Method),” ASTM International (2013); ASTM Standard D3884-09, “Standard Test Method for Abrasion Resistance of Textile Fabrics (Rotary Platform, Double-Head Method),” ASTM International (2013); ASTM Standard D3597-02, “Standard Specfication for Woven Upholstery Fabrics-Plain, Tufted or Flocked,” ASTM International (2009); ASTM Standard D4037-02, “Standard Performance Specification for Woven, Knitted or Flocked Bedspread Fabrics,” ASTM International (2008); ASTM Standard D1117-01, “Standard Guide for Evaluating Nonwoven Fabrics,” ASTM International (2001). In some embodiments, the substrate is a fabric (e.g., a nonwoven fabric), and the durability of the composite material is increased by about 1%, 2%, 3%, 4%, 5%, 6%, 7%, 8%, 9%, 10%, 15%, 20%, 25%, 30%, 35%, 40%, 45%, 50%, 55%, 60%, 65%, 70%, 75%, 80%, 85%, 90%, 95%, 100%, 125%, 150%, 175%, 200%, 250%, 300% or more as compared to a control fabric having the same amounts/types of fibers, weight, thickness as the fabric of the composite material.

Fabrics and/or composite materials of the present invention may demonstrate enhanced abrasion resistance. In some embodiments, the abrasion resistance of a fabric and/or composite material is increased by about 1%, 2%, 3%, 4%, 5%, 6%, 7%, 8%, 9%, 10%, 15%, 20%, 25%, 30%, 35%, 40%, 45%, 50%, 55%, 60%, 65%, 70%, 75%, 80%, 85%, 90%, 95%, 100%, 125%, 150%, 175%, 200%, 250%, 300% or more as compared to a control material (i.e., a substrate that lacks the porous polymer coating and/or icephobic coating but is otherwise identical to the fabric/composite material) when tested based on ASTM Standard D4157-13, “Standard Test Method for Abrasion Resistance of Textile Fabrics (Oscillatory Cylinder Method),” ASTM International (2013); ASTM Standard D4158-08, “Standard Guide for Abrasion Resistance of Textile Fabrics (Uniform Abrasion),” ASTM International (2012); ASTM Standard D3389-10, “Standard Test Method for Coated Fabrics Abrasion Resistance,” ASTM International (2010); ASTM Standard D3885-07a, “Standard Test Method for Abrasion Resistance of Textile Fabrics (Flexing and Abrasion Method),” ASTM International (2011); ASTM Standard D3886-99, “Standard Test Method for Abrasion Resistance of Textile Fabrics (Inflated Diaphragm Apparatus),” ASTM International (2011); ASTM Standard D4966-12, “Standard Test Method for Abrasion Resistance of Textile Fabrics (Martindale Abrasion Tester Method),” ASTM International (2013); ASTM Standard D3884-09, “Standard Test Method for Abrasion Resistance of Textile Fabrics (Rotary Platform, Double-Head Method),” ASTM International (2013); ASTM Standard D3597-02, “Standard Specification for Woven Upholstery Fabrics-Plain, Tufted or Flocked,” ASTM International (2009); ASTM Standard D4037-02, “Standard Performance Specification for Woven, Knitted or Flocked Bedspread Fabrics,” ASTM International (2008); ASTM Standard D1117-01, “Standard Guide for Evaluating Nonwoven Fabrics,” ASTM International (2001). In some embodiments, the substrate is a fabric (e.g., a nonwoven fabric), and the abrasion resistance of the composite material is increased by about 1%, 2%, 3%, 4%, 5%, 6%, 7%, 8%, 9%, 10%, 15%, 20%, 25%, 30%, 35%, 40%, 45%, 50%, 55%, 60%, 65%, 70%, 75%, 80%, 85%, 90%, 95%, 100%, 125%, 150%, 175%, 200%, 250%, 300% or more as compared to a control fabric having the same amounts/types of fibers, weight, thickness as the fabric of the composite material.

Fabrics and/or composite materials of the present invention may demonstrate enhanced adhesive properties. In some embodiments, the adhesiveness of a fabric and/or composite material is increased by about 1%, 2%, 3%, 4%, 5%, 6%, 7%, 8%, 9%, 10%, 15%, 20%, 25%, 30%, 35%, 40%, 45%, 50%, 55%, 60%, 65%, 70%, 75%, 80%, 85%, 90%, 95%, 100%, 125%, 150%, 175%, 200%, 250%, 300% or more as compared to a control material (i.e., a substrate that lacks the porous polymer coating and/or icephobic coating but is otherwise identical to the fabric/composite material) when tested based on AATTC Standard 136, “Bond Strength of Bonded and Laminated Fabrics,” American Association of Textile Chemists and Colorists, (2012); ASTM Standard D6862-11, “Standard Test Method for 90 Degree Peel Resistance of Adhesives,” ASTM International (2012); ASTM Standard D3167-10, “Standard Test Method for Floating Roller Peel Resistance of Adhesives,” ASTM International (2010); ASTM Standard D2724-07, “Standard Test Methods for Bonded, Fused, and Laminated Apparel Fabrics,” ASTM International (2011); H N Standard 0192, “Test Method for Determining Bond Strength of Laminated Fabrics,” (2007). In some embodiments, the substrate is a fabric (e.g., a nonwoven fabric), and the adhesiveness of the composite material is increased by about 1%, 2%, 3%, 4%, 5%, 6%, 7%, 8%, 9%, 10%, 15%, 20%, 25%, 30%, 35%, 40%, 45%, 50%, 55%, 60%, 65%, 70%, 75%, 80%, 85%, 90%, 95%, 100%, 125%, 150%, 175%, 200%, 250%, 300% or more as compared to a control fabric having the same amounts/types of fibers, weight, thickness as the fabric of the composite material.

A composite article (e.g., a composite material) of the present invention may be suitable for use in numerous applications and products, including, but not limited to, transportation applications, building applications, architectural applications, automobiles, aircraft, air ducts, appliances, baffles, ceiling tiles, and office partitions.

### EXAMPLES

### Example 1

### Icephobic Treatment:

A number of compositions were prepared and applied to a fabric to test icephobicity. Specifically, a 60-gsm black 100% polyester spunlaced nonwoven was pad finished with a composition containing 4-20% by weight of a C-6 fluoropolymer or catalyzed polysiloxane emulsion, 10-20% by weight of a latex binder including a polymer type selected from: acrylic, styrene-acrylic, acrylonitrile, acrylic-urethane, PVC, and polyester, and 60-86% by weight water. For some compositions, 5% by weight blocked isocyanate cross-linker and/or 10% by weight non-halogenated flame retardant can be added to the composition, which may improve surface toughness against abrasion and/or impart flame resistance, respectively.

The compositions were saturation-applied onto a fabric (i.e., the fabric was submerged in the composition) in a single mix application and nipped between two composite or steel rollers to a wet pickup of 150-180%. The chemically-impregnated nonwoven was dried and cured at 350° F. for approximately 30 seconds.

### Fabric Mechanical Treatment:

Some of the coated nonwovens were calendered (e.g., using steel/composite rolls) to smooth and consolidate the fibers on the nonwoven surface. Under low temperature/high pressure, for example, 120-200° C./1,000-2,000-pli, pre/post-gravel-o-meter icephobicity values were significantly improved. Under high temperature/low pressure, for example, 215° C./315-phi, the icephobicity results worsened.

### Acoustic Coating Application:

The opposing side of the coated nonwoven (side two) was coated with an acoustics-providing adhesive coating that contained coating solids of 20% PVC binder, 9% kaolin clay filler, 9% ATH filler, and less than 1% each of surfactants, rheology modifiers, and foaming agents. The acoustic coating composition was foamed to approximately a 5:1 blow ratio of air to liquor, and was applied by a froth finish incremental applicator to a dry add-on of 1-2 osy. The coated fabric was dried and cured at 300° F. for approximately a minute.

### Creating Composite Part:

The impregnated/coated nonwoven was laid (acoustic coating down) on top of a about 600-gsm PET/Co-PET needlepunched nonwoven and molded into a flat panel in a two-step process: (1) The layered sample was placed in a heated platen press which was shimmed to 6-mm to control the first step composite thickness and pressed at 400° F. for 60 seconds to create a smooth and consolidated surface by imbedding the nonwoven fibers into the binder. (2) The molded sample was immediately removed from the press and placed in an unheated platen press for 60 seconds, which was shimmed to 3-mm, and pressed to its final thickness to simulate a customer application. This step consolidates the surface of the coated fabric and results in the targeted composite thickness.

### Icephobicity Testing:

The icephobicity results for certain compositions, which are provided in Table 4, after the fabric underwent calendering at a temperature of 130° C. at 1,600 pH, application of the acoustic coating, and attachment to a substrate to prepare a composite part are shown in Table 4. Each composite was tested using Toyota Engineering Standard test TSL3618G. To simulate gravel exposure, a chipping method was used as described in Toyota Engineering Standard Test TSL3618G section 4.11.1 using a gravelometer device described in test method ASTM D3173-03. For icephobicity testing, Toyota Engineering Standard test TSL3618G section 4.16.1 was used to test prior to subjecting to chipping and Toyota Engineering Standard test TSL3618G section 4.16.2 was used to test after chipping. The specifications for testing the icephobicity according to this method are found in Table 1 of Toyota Engineering Standard test TSL3618G. The force necessary to pull the ice from the coated fabric of the composite (i.e., the peeling load) is referred to as icephobicity and the peeling loads are reported before and after chipping (in the table referred to as pre-gravel and post gravel, respectively). No samples cracked or failed the chipping testing.

TABLE 4
Icephobicity results for example compositions including a repellant, latex
binder and water that were saturation and applied onto a nonwoven.
Nonwoven: 100% Black PET Spunlace
Saturation Application

| Repellant Chemistry | | Latex Chemistry | | X- | Icephobicity (N) | |
|---|---|---|---|---|---|---|
| | Weight | | Weight | Linker | Pre- | Post |
| Name | % | Name | % | XAN | Gravel | Gravel |
| Nuva 2155 | 4 | Synthebond SA-100 | 9 | 0 | 2.5 | 14.3 |
| (fluoropolymer) | 5 | (acrylic) | 10 | 5 | 1.7 | 3.7 |
| | 4 | Binder NE 34R-2 | 9 | 0 | 10.5 | 15.5 |
| | | (acrylonitrile) | | | | |
| | 4 | Synthebond US-120 | 9 | 0 | 2.5 | 20.2 |
| | | (acrylic-urethane) | | | | |
| | 4 | Synthebond SA-134 | 9 | 0 | 8.5 | 11.8 |
| | | (acrylic-styrene) | | | | |
| | 4 | Synthebond AC-235 | 9 | 0 | 5.2 | 27.3 |
| | | (acrylic) | | | | |
| | 4 | Builder AC-40 | 9 | 0 | 3.6 | 25 |
| | | (polyester) | | | | |
| | 4 | Dicryaln 7835 | 9 | 0 | 4.1 | 12.7 |
| | | (polyester) | | | | |
| | 5 | Dicryaln 7835 | 10 | 5 | 2.9 | 14.5 |
| | | (polyester) | | | | |
| | 4 | Plasticryl NA4-1 | 9 | 0 | 1.6 | 13.4 |
| | | (acrylic) | | | | |
| | 5 | Plasticryl NA4-1 | 10 | 5 | 2.1 | 28.5 |
| | | (acrylic) | | | | |
| | 4 | Vycar 660x14 | 9 | 0 | 4.5 | 8.9 |
| | | (PVC) | | | | |
| | 5 | Vycar 660x14 | 10 | 5 | 2.7 | 10.2 |
| | | (PVC) | | | | |
| Starpel 366 | 4 | Synthebond SA-100 | 9 | 0 | 5.4 | 15.8 |
| (silicon | | (acrylic) | | | | |
| containing | 20 | Synthebond SA-100 | 10 | 0 | 10.5 | Not tested |
| compounds) | | (acrylic) | | | | |

### Example 2

### Icephobic Treatment:

A 60-gsm black 100% polyester spunlaced nonwoven was foam coated (a.k.a., skim coated) on side one with a composition composed of 4-20% by weight of a C-6 fluoropolymer, 10-20% by weight of a latex binder including a polymer type selected from: acrylic, styrene-acrylic, acrylonitrile, acrylic-urethane, PVC, polyester, and carboxylated acrylonitrile-butadiene copolymer, and 60-86% by weight water. For some compositions, 5% by weight blocked isocyanate cross-linker and/or 10% by weight non-halogenated flame retardant can be added to the formulation, which may improve surface toughness against abrasion and/or impart flame resistance, respectively. Various surfactants, rheology modifiers, and foaming aids can be added to the composition for foaming at no more than 1% by weight each. The compositions were foamed to 4.0-5:1 blow ratio of air to liquor and applied to the surface of the nonwoven to a coat weight of approximately 0.5-2 oz of coating add-on using a froth finish incremental applicator. The foam-treated nonwoven was dried and cured at 350° F. for approximately 60 seconds. While not wishing to be bound to any particular theory, it is believed that this method of application allowed for a concentration-gradient of chemistry where the surface of the coated fabric (to which the composition was applied) had a higher concentration of repellant/binder chemistry compared to the concentration of the repellant/binder at the center of the nonwoven.

Some of the coated nonwovens were calendered, applied with an acoustic coating, and/or used to form a composite part as described in Example 1.

The icephobicity results for certain compositions, which are provided in Table 5, after the fabric underwent calendering at a temperature of 215° C. at 300 pli, application of the acoustic coating, and attachment to a substrate to prepare a composite part are shown in Table 5. Each coated fabric underwent calendaring, included an acoustic coating, and was attached to a substrate to prepare a composite part as described in Example 1, and was tested using Toyota Engineering Standard test TSL3618G as described in Example 1.

TABLE 5
Icephobicity results for example compositions including a repellant, latex
binder and water that were foam coated onto a nonwoven
Foam (“Skim-Coat”) Application

| Repellant Chemistry | | Latex Chemistry | | Cross- | Icephobicity (N) | |
|---|---|---|---|---|---|---|
| | Weight | | Weight | Linker | Pre- | Post- |
| Name | % | Name | % | XAN | Gravel | Gravel |
| Nuva 2155 | 5 | Plasticryl NA4-1 | 20 | 0 | 1.3 | 1.9 |
| (fluoropolymer) | | (acrylonitrile) | | | | |
| Nuva 2155 | 5 | Nychem XPE 140 | 20 | 0 | 1.3 | 2.1 |
| (fluoropolymer) | | (carboxylated | | | | |
| | | acrylonitrile- | | | | |
| | | butadiene | | | | |
| | | coplymer) | | | | |

### Example 3

### Icephobic Treatment:

A 55-gsm woven composed of 100% polyester fiber was pad finished with a composition including 4-20% by weight of a C-6 fluoropolymer or catalyzed polysiloxane emulsion, 0-20% by weight of a latex binder including a polymer type selected from: acrylic, styrene-acrylic, acrylonitrile, acrylic-urethane, PVC, and polyester, and 60-92% by weight water. For some compositions, 5% by weight blocked isocyanate cross-linker and/or 10% by weight non-halogenated flame retardant can be added to the formulation, which may improve surface toughness against abrasion and/or impart flame resistance, respectively. The compositions were saturation-applied (i.e., fabric was submerged in the composition) in a single mix application and nipped between two composite or steel rollers to a wet pickup of 150-180%. The chemically-impregnated woven was dried and cured at 350° F. for approximately 30 seconds.

Some of the coated wovens were calendered, applied with an acoustic coating, and/or used to form a composite part as described in Example 1.

The icephobicity results for certain compositions, which are provided in Table 6, after the fabric underwent calendering at a temperature of 215° C. at 300 pli, application of the acoustic coating, and attachment to a substrate to prepare a composite part are shown in Table 6. Each coated fabric underwent calendaring, included an acoustic coating, and was attached to a substrate to prepare a composite part as described in Example 1, and was tested using Toyota Engineering Standard test TSL3618G as described in Example 1.

TABLE 6
Icephobicity results for example compositions including a
C-6 fluoropolymer, water, and optionally a latex binder,
which were saturation applied onto a woven fabric.
Woven 55 gsm 100% Polyester
Saturation Application

| | | Latex Chemistry | | Icephobicity, N | |
|---|---|---|---|---|---|
| Repellant Chemistry | % | | % | Pre- | Post |
| Name | Weight | Name | Weight | Gravel | Gravel |
| Nuva 2155 | 8 | Sythebond | 9 | 14 | 3.1 |
| (fluoropolymer) | | SA-100 | | | |
| | | (acrylic) | | | |
| Nuva 2155 | 8 | n/a | 0 | 3 | 5 |
| (fluoropolymer) | | | | | |

### Example 4

### Icephobic Treatment:

A 55-gsm woven composed of 100% polyester fiber was pad finished with a composition including 10-20% by weight Syl-off 7920 polymerizing silicone emulsion, 2% by weight Syl-off 7922 platinum-catalyzed emulsion, and 78-88% by weight water. The compositions were saturation-applied (i.e., fabric was submerged in the composition) in a single mix application and nipped between two composite or steel rollers to a wet pickup of 100%. The impregnated woven was dried and cured at 350° F. for approximately 30-seconds.

Some of the coated wovens were calendered, applied with an acoustic coating, and/or used to form a composite part as described in Example 1.

The icephobicity results for a composition are provided in Table 7, after the fabric underwent calendering at a temperature of 215° C. at 300 pH, application of the acoustic coating, and attachment to a substrate to prepare a composite part are shown in Table 7. The coated fabric underwent calendaring, included an acoustic coating, and was attached to a substrate to prepare a composite part as described in Example 1, and was tested using Toyota Engineering Standard test TSL3618G as described in Example 1.

TABLE 7
Icephobicity results for an example composition including a
polymerizing silicone emulsion and water that was saturation
applied onto a woven fabric.
Woven 55 gsm 100% Polyester
Saturation Application

| Repellant Chemistry | | Latex Chemistry | | Icephobicity, N | |
|---|---|---|---|---|---|
| Name | % Weight | Name | % Weight | Pre-Gravel | Post Gravel |
| Syl-off 7922 | 20 | n/a | 0 | 24 | 5 |
| (silicone) | | | | | |

### Example 5

The icephobicity results for a composition including Nuva 2155 in an amount of 4% by weight of the composition, Synthebond SA-110 in an amount of 9% by weight of the composition, and water in an amount of 87% by weight of the composition, which was pad finished onto a nonwoven fabric as described in Example 1, are provided in Table 8. The nonwoven fabric was a 2.13-osy 60% wood pulp/40% polyester staple fiber spunlace fabric. To determine the effects of calendaring on the coated fabric, one sample was not calendered, one sample was calendered at a temperature of 130° C. at 1,600 pH and another sample was calendered at a temperature of 215° C. at 300 pli. An acoustic coating was then attached to each of the samples and then attached to a substrate to prepare a composite part as described in Example 1. Icephobicity was tested using Toyota Engineering Standard test TSL3618G before Gravelometer Testing as described in Example 1, and the results are shown in Table 8.

TABLE 8
Pre-gravel icephobicity results for an example composition.
Pre-Gravel Repellent/Binder Treated 08851

| No | Calender #4 | Calender #1 |
|---|---|---|
| Calender | (130° C.; 1,600-pli) | (215° C.; 300-pli) |
| 6.8-N | 3.2-N | 18.2-N |

### Example 6

Coated fabric samples were prepared to include a porous polymer acoustic coating at a dry add-on of approximately 60 gsm onto a 54 gsm spunlace greige (70% PET/30% rayon). Coatings used were Formula 1 from Table 3 with 22% Clay (Imerys Hydrite® SB100) incorporated by weight of the solids. Samples were subjected to a temperature of 380° F. for 2.5 minutes. Air permeability of the samples was measured prior to and after heating.

Table 9 compares the Change of Air Permeability of Formula 1 with the incorporation of Imerys Hydrite® SB100 at a level of 22% in the coating solids vs no clay incorporation. Table 9 demonstrates the impact of clay pigments on the air permeability stability of the samples when they are heated as described above.

TABLE 9
Effect on Air Permeability Heat Stability
of Clay Incorporation in Formula A

| | Air | Air | | |
|---|---|---|---|---|
| | Perm | Perm | | |
| Sample | (CFM) | (CFM) | | |
| Coating | Prior | After | Delta Air | % Delta Air |
| Formula 1 | to Heat | Heat | Permeability | Permeability |
| No Clay | 42.6 | 138.0 | 95.4 | 224% |
| 22% Clay | 84.2 | 105.2 | 21 | 25% |

3.7 osy PET needle-punch fabric having a thickness in a range of about 0.036 inches to about 0.044 inches was used as the surrogate “bond-to” substrate for bond testing with two different formulations. Coatings used were Formula 1 from Table 3 with 22% Clay (Imerys Hydrite® SB100) incorporated by weight of the solids and Formula A from Table 2 with 22% Clay (Imerys Hydrite® SB100) incorporated by weight of the solids. The coating formulations were separately applied onto a 54 gsm spunlace greige (70% PET/30% rayon) at a dry add-on of approximately 60 gsm, and dried in laboratory tenter frame to provide a dried fabric sample. The dried fabric sample was then stacked (like sandwich) with the coated side facing the 3.7 osy PET needle-punch fabric (i.e., with the coating of Formula 1 or Formula A facing and/or in contact with a surface of the PET needle-punch fabric), but are not bonded together to provide stacked sample (pre-bonded sample). The air permeability was measured for the stacked sample. Then, the stacked sample was bonded to the 3.7 osy PET needle-punch at a temperature of 380° F. for 1 minute at a set gap of 0.05 inches (resulting in less than 10 psi pressure) to provide a bonded sample. The air permeability of the bonded sample was then measured. The change in air permeability, or “Delta Air Permeability” is the difference between these two measurements (i.e., the pre-bonded and post-bonded measurements).

Tables 10 and 11 show the impact of clay incorporation Imerys Hydrite® SB100 in Formula 1 and Formula A coating formulations on the stability of the coated-fabric's air permeability when the fabric is subjected to a simulation of a manufacturers bonding process (bonding at 380° F. at a pressure of <10 psi for one minute). As clay content is increased, the change in air flow before and after the bonding process is substantially reduced demonstrating the positive effect of incorporating clay into the coating formulation.

TABLE 10
Effect on Air Permeability Stability during
Bonding of Clay Incorporation in Formula 1

| | Air Perm | Air Perm | | |
|---|---|---|---|---|
| Sample | (CFM) | (CFM) | | |
| Coating | Prior to | After | Delta Air | % Delta Air |
| Formula 1 | Bonding | Bonding | Permeability | Permeability |
| No Clay | 46.0 | 19.4 | 26.6 | 58% |
| 22% Clay | 39.2 | 25.8 | 13.4 | 34% |

TABLE 11
Effect on Air Permeability Stability during
Bonding of Clay Incorporation in Formula A

| | Air | Air | | |
|---|---|---|---|---|
| | Perm | Perm | | |
| Sample | (CFM) | (CFM) | | |
| Coating | Prior to | After | Delta Air | % Delta Air |
| Formula A | Bonding | Bonding | Permeability | Permeability |
| No Clay | 19.08 | 13.70 | 5.38 | 28% |
| 22% Clay | 17.3 | 16.4 | 1.97 | 6% |

FIG. 5 and FIG. 6 show the impact of incorporation of high aspect ratio clays on the air permeability of two substrates. FIG. 5 shows a porous base fabric (54 gsm untreated 70/30 PET/Rayon spunlace) with a starting air permeability of approximately 385 cfm. FIG. 6 shows a less porous, treated fabric (54 gsm fluorocarbon-treated wood pulp PET spunlace). The samples in FIG. 6 were generated using a coating add-on of 42 gsm.

FIG. 5 demonstrates how clay can be used to provide a coating that can achieve a specific air permeability target on porous fabric without the need to incorporate hold-out treatments via fabric finishing.

FIG. 6 shows that with the incorporation of higher concentrations of high-aspect ratio clays in a coating formulation, more stable (% lower Delta Air Permeability) air permeabilities can be achieved before and after bonding (as described previously). Similarly, both FIGS. 5 and 6 show that a higher percentage of clay in the coating formulation lowers air permeability of the coating. Data for FIG. 5 were generated on the 54 gsm 70/30 PET/rayon spunlace, which has a uncoated air permeability of 385 cfm. Data for FIG. 6 were generated with 42 gsm of coating on a finished 53 gsm wood pulp/PET spunlace, which has an uncoated air permeability of 135 cfm.

The foregoing is illustrative of the present invention, and is not to be construed as limiting thereof. The invention is defined by the following claims, with equivalents of the claims to be included therein.

1. A composition comprising:
a repellant in an amount of about 1% to about 30% by weight of the composition, wherein the repellant comprises a fluorine containing compound and/or a silicon containing compound, and
water in an amount of about 50% to about 98% by weight of the composition.

2. The composition of claim 1, wherein the composition comprises at least one fluorine containing compound.

3. The composition of claim 1, wherein the composition comprises at least one silicon containing compound.

4.-15. (canceled)

16. A fabric comprising a repellant on a first surface of the fabric, wherein the repellant comprises a fluorine containing compound and/or silicon containing compound, optionally wherein the repellant is present in an amount of about 1% to about 30% by weight of the fabric.

17. The fabric of claim 16, further comprising a latex binder on the first surface of the fabric.

18. (canceled)

19. The fabric of claim 16, wherein the repellant is cured on the first surface of the fabric.

20. The fabric of claim 16, wherein the fabric is a woven fabric or a nonwoven fabric.

21. The fabric of claim 16, wherein the fabric comprises a spunlaced nonwoven fabric.

22. The fabric of claim 16, wherein the fabric comprises polypropylene fibers, polyethylene fibers, polylactic acid fibers, polyester fibers, wood pulp fibers, and/or blends and/or bicomponent fibers thereof.

23. The fabric of claim 16, wherein the fabric has a basis weight of about 10 grams per square meter to about 2000 grams per square meter.

24. The fabric of claim 1, wherein the repellant is throughout at least a portion of the thickness of the fabric.

25.-26. (canceled)

27. The fabric of claim 1, wherein the repellant or a component thereof on the first surface of the fabric is in a concentration gradient in which the repellant or a component thereof increases in concentration from the side of the fabric opposing the first surface to the first surface.

28. The fabric of claim 16, further comprising a porous polymer coating on a second surface of the fabric, the second surface opposing the first surface.

29.-41. (canceled)

42. The fabric of claim 16, wherein the fabric comprising the repellant has increased weather resistance and/or ice release compared to a fabric devoid of the repellant.

43. The fabric of claim 16, wherein the fabric comprising the repellant has increased durability compared to a fabric devoid of the repellant.

44. The fabric of claim 16, wherein the fabric comprising the repellant releases ice with a peeling load of less than about 30, 25, 20, 15, 10, or 5 Newtons as measured in accordance with Toyota Engineering Standard test TSL3618G.

45. The fabric of claim 16, wherein the fabric comprising the repellant has increased sound absorption compared to a fabric devoid of the repellant.

46. A composite article comprising:
a substrate; and
a fabric comprising an icephobic coating on a first surface and a porous polymer coating on a second surface,
wherein the second surface contacts at least one surface of the substrate.

47.-51. (canceled)

52. A method of providing a coated fabric of claim 16, the method comprising:
contacting the first surface of the fabric with a composition comprising the repellant to provide the coated fabric, wherein the repellant comprises a fluoropolymer and/or a polysiloxane; and
drying the coated fabric.

53.-61. (canceled)

62. A method of providing a composite of claim 46, the method comprising:
contacting a substrate and a fabric, the fabric comprising an icephobic coating on a first surface and a porous polymer coating on a second surface to form the composite,
wherein the second surface of the fabric contacts at least one surface of the substrate.

63.-71. (canceled)
